(19) United States
(12) Patent Application Publication
(10) Pub. No.: US 2001/0004098 A1
(43) Pub. Date: Jun. 21, 2001

(54) ADVANCED TECHNOLOGY PROPULSION STUDY

(76) Inventors: BOYD E. SMITH, BREMERTON, WA (US); MERVIN C. VINCENT, KENT, WA (US)

Correspondence Address: DAVID L GARRISON, GARRISON AND ASSOCIATES, 2001 SIXTH AVENUE, SUITE 3300, SEATTLE, WA, 981212522

(21) Appl. No.: 08/888,932

(22) Filed: Jul. 7, 1997

(51) Int. Cl. B64G 1/00

(52) U.S. Cl. 244/172; 416/98

(57) ABSTRACT

A thrust levitation mechanism comprising a main rotor having a plurality of lifting rotor locations about the periphery thereof driven lifting rotors located at each lifting rotor location, said lifting rotors each having a rotational axis substantially in the plane of said main rotor and positioned at substantially a right angle to radii of said main rotor. Bob rotors or disc rotors may be used as the lifting rotors and may be angled out of the plane of the main rotor to induce thrust at an angle to the axis of the main rotor or to otherwise induce thrust asymmetrically. The thrust levitation devices of this invention are useful to induce movement in vehicles including automobiles, airplanes and space ships, among other applications. Use of paired, counter rotating main rotors and a plurality of levitation devices are contemplated.

### BACKGROUND ART

This invention relates to thrust levitation and more particularly to methods and means for inducing thrust levitation for purposes such as powering terrestrial vehicles and spacecraft.

### DISCLOSURE OF INVENTION

The information and inventions described herein presents a conceptual, mathematical physics, and engineering design description for a rudimentary thrust levitation mechanical system, a mechanism. Thrust levitation reaction force propulsion (driven torque and reaction forces and torque), as described and developed herein, is capable of providing the propulsive forces that are needed in order to lift a vehicle, propel a vehicle in any desired direction, and provide the control forces that are needed in order to maneuver and maintain control of the vehicle (i. e. maneuver and maintain control of the attitude, true course, and speed of a vehicle). Inertial levitation technology, i. e. thrust levitation, is the technology used by a vehicle with a propulsion system that can convert vehicle onboard power into linear inertia, without using the expulsion of mass, as is done by a rocket, or the movement of air or water as is done by aircraft propellers and the screws of marine boats and ships. Traction and repulsion beam force fields are produced when a thrust levitation propulsion system is powered up and then held in place such that it cannot move. The System International, SI, MKS system of units are used throughout this invention disclosure for most of the computations. The initial values for the analyses and the results are generally displayed in the British Gravitational system of units, i. e. the inch-pound units. The discussions in the text are typically presented in terms of the British Gravitational system of units since they are familiar to most laymen and are intuitively understood by most English speaking persons.

When a thrust levitation system is used in order to produce inertial field force beams, then such a system is referred to as an inertial field force beam system, traction beam system, or repulsion beam system. Extensions of such systems include impulse force beam systems, projectile firing systems that propel a projectile with an impulse force beam, sensory systems that measure the mass of small objects remotely by engaging the small object with a force beam, pumps that propel liquids with force beams, and et cetera. An interesting application would be to over-fly the ground at low altitude with a wide area coverage and powerful repulsion beam directed at the ground in order to set off land mines and thereby clear many of the mines from a mine field from a safe distance above in the air.

If the thrust levitation system described herein is oriented such that the axis is directed towards the left, the system is held in place, and the rotor systems are powered up, then traction and repulsion beams are simultaneously directed towards the left and right respectively. The inertial field force beam to the left of this inertial field force beam system is a traction beam. The inertial field force beam to the right of this inertial field force beam system is a repulsion beam.

The inertial field force beam attributes such as focal point, beam width, field intensity, and et cetera can be controlled by varying the geometry of the inertial field force beam system rotor mechanisms. Such inertial field force beam systems can be analyzed by using approaches that are similar to the analysis techniques that are presented herein. Force beam mechanisms that are considered to be equivalent and extensions of the system features described herein are, for example, variable geometry disk rotors and moving chain disk rotor systems that allow the beam attributes mentioned above to be controlled and changed. The attractive beam fields and forces that are produced by an inertial field force beam system are similar to or are equivalent to gravitational fields and forces. Repulsive beam fields and forces are similar, but are opposite in effect or sign to those of traction beam fields and forces.

The predicted effect for the concept and phenomena of spacial warp is that a three-dimensional inner volume increase for a structure can be produced by applying a traction beam inside of an enclosed volume. Spacial warp can make more usable space available inside of a craft than appears to be available based on the outside dimensions of the craft. The effect is that traction beam energy can be expended in order to increase the usable and available space inside of a small craft. Spacial warp is defined and discussed in subsequent sections of this disclosure.

It is postulated by the inventors, based partially on the information in the following section on the concept of a gravitational field volume distortion generator, that traction and repulsion beams can distort the normal three dimensional space inside of a metallic structure. The concept is that when, for example, a radial traction beam field is employed within an enclosed space, such as a metallic cylindrical volume with an inner radius r and an inner height h, that to an observer inside of this cylindrical space, the inner radial dimension r will be measured to have clearly and significantly increased when a traction beam is activated. For example, an observer inside of a cylindrical volume will observe that the usable space within the cylinder has increased significantly if the traction beam field has an intensity that produces on the order of a 1 g₀ centrally directed inertial attractive field, i. e. an inertial field traction force beam, effect directed at the perimeter edge of the cylinder and along the inner cylinder wall. When the traction beam is engaged, an observer inside of the cylinder will observe that the diameter of the cylinder and available space inside of the cylinder has been increased significantly by spacial warp, while an observer on the outside of the cylinder will not observe any differences in the apparent dimensions of the cylinder and will still measure that the cylinder has the same dimensions that it had before the traction beam field was activated.

It is interesting to note that a centrally directed traction beam is essentially equivalent to a gravitational cylindrical potential well that is centered on the axis of a cylinder. This equivalent potential well could be defined mathematically as and in terms of an equivalent gravitational mass that is located along the central axis of the cylinder.

The analyses in this disclosure extend the fundamental concepts of classical mechanics to include the concepts of driven torque, reactive torque, reactive forces, and associated momentum balancing systems. These new concepts are then used in the subsequent sections of this book in order to explain how to convert vehicle on-board energy directly into linear inertia which can produce vehicle thrust without using rocket propulsion. Also, thrust levitation technology includes the inertial field force beam and spacial warp technologies. Thrust levitation propulsion converts vehicle energy directly into vehicle accelerating force by using new physical concepts, engineering principles, and technologies that can operate equally well within planetary atmosphere or elsewhere in space.

Essentially, it can be stated that a thrust levitation system configuration, as illustrated herein, produces a “torque to force transformation” that converts engine driven torque into a reactive force that lifts or thrusts the illustrated vehicle propulsive systems in the chosen direction.

The new concepts that are developed and explored herein use gravitational potential dynamic analyses in resisting mediums in order to develop mathematical expressions that can be used to characterize, design, and evaluate the performance of thrust levitation propulsion vehicles. This disclosure both defines and illustrates how thrust levitation vehicle parametric designs can be analyzed and evaluated.

The thrust levitation analysis techniques are extendible to other vehicle types and classes. Additionally, these techniques can be extended to whole new types of systems such as, for example, marine applications and industrial equipment and systems. For example, thrust levitation systems could be used to provide vertical lift capabilities for building construction, for elevator systems, and various maintenance activities.

A key attribute of the new break-through concepts are that they use vehicle onboard engine power in order to produce standard engine torque which is then converted into vehicle thrusting force without employing marine boat and marine ship screws, aircraft propellers, jet thrust, or rocket thrust.

Another key aspect of the approach of thrust levitation is that, as a motive power source, it appears to be highly efficient, possibly more than 90 percent efficient (i. e. in terms of the utilization of the available engine power).

Spacial warp can be described, in summary, by saying that it produces dimensional volume change effects for enclosed structures when inertial field force beam systems are engaged within and/or adjacent to enclosed volumes. The vertical thrust levitation propulsion defined in the z direction can be extended in order to provide thrust in the horizontal plane, i. e. in the (x, y) plane, by controlling and dynamically varying the orientation of the disk rotor configuration illustrated as the main rotor rotates in the azimuthal φ direction.

Bob rotors, can be substituted for, or replace the disk rotors used in thrust levitation systems. A bob rotor comprises a rotor hub with short rotor arms that each support a bob mass. The advantage of bob rotor systems is that they can be configured such that the bob rotors are free wheeling and are automatically and efficiently powered by reactive torque. It is also possible to use free wheeling main rotors with free wheeling bob rotors that are associated with powered prop rotors. Thrust levitation systems that are implemented with bob rotor configurations can be designed such that they implement the pitch and skew angle control mechanisms that are described below. Although bob rotor mechanisms are difficult to analyze and are only described in this invention disclosure and patent application by using descriptive design discussions that characterize their performance, bob rotor configurations are considered to be geometric configurational extensions of the concepts that are analyzed herein and, therefore bob rotor mechanisms are being claimed as part of this invention.

The orientation angle, α, of a disk rotor, about a main rotor arm is referred to as the pitch angle of a disk rotor or a bob rotor. The pitch angle of a disk rotor can be used in order to nearly instantaneously control or modulate the vertical reactive force that is produced by a lifting disk rotor as it is swept by a main rotor arm about the vertical axis of the main rotor. The orientation angle, φₛ, of a disk rotor about the vertical axis through the center of a disk rotor, (the z″ axis) is referred to as the skew angle of a disk rotor. The heading of a vehicle can be controlled by using horizontal reactive forces that can be produced in order to propel a vehicle in a forward direction or in some other desired heading direction, Hd. For example, the skew angles, φₛ, of the disk rotors in a main rotor system can be used in order to control the direction of the applied vehicle horizontal reactive forces such that these forces are applied in the direction of the vehicle desired heading. The direction of the horizontal reactive force, due to a particular disk rotor, is controlled by dynamically varying the disk rotor skew angle as the associated main rotor arm is rotated about the axis of the main rotor, i. e. as a function of the main rotor arm angular position. The skew angle, φₛ for a disk rotor is defined as φₛ=−φₛ_{_{—}}_{Max} COS (Swayₛ−φ−H_{d}) where, when Swayₛ=1 then Hd is the desired vehicle heading direction for the horizontal reactive force that is propelling the vehicle in the horizontal direction. φₛ_{_{—}}_{Max} is the maximum disk rotor skew angle through which the disk rotor is being dynamically and cyclically moved back and forth about a vertical axis through the disk rotor as the associated main rotor arm rotates about the main rotor axis, as is illustrated in FIGS. 4 and 5.

Swayₛ is a rate factor that, when it is set to a value of less than 1, results in a horizontal reactive force being applied such that it sweeps around the perimeter edge of the vehicle in a clockwise direction as a function of the main rotor arm angle φ. When the value of Swayₛ is increased above a value of 1, then a horizontal reactive force is swept around the perimeter edge of the vehicle in a counter clockwise direction. Also, for example, the sweep rate of this horizontal reactive force decreases gradually as Swayₛ is gradually decreased below 1.

Inertial field force beams are produced by the thrust levitation system described herein and illustrated in FIG. 3 when this thrust levitation system is held in place and driven power is applied to the main rotor and the disk rotors.

In a preferred embodiment of this invention, torque is applied to a main rotor and to a single disk rotor at the end of each of a plurality of arms on the main rotor, each with an attached lifting disk. For a vehicle lifting configuration with both upper and lower counter rotating main rotors this last statement is identically true for the upper main rotor and lifting disk systems and the lower main rotor and lifting disk systems. The upper and lower main rotor systems, in terms of their configurations, are mirror images of each other.

A key feature of the upper and lower main rotor systems is that their combined angular momentum sum to zero, which allows the vehicle to maneuver without being affected by a total non-zero vehicle angular momentum vector. Single main rotor vehicle configurations are practical, but are conceptually more complicated than counter rotating dual main rotor systems. Also, single main rotor configurations require angular momentum balancing mechanisms and systems.

A particularly interesting single main rotor vehicle configuration, which is one preferred embodiment of this invention, is the seven sided star wheel heptagon main rotor configuration illustrated in the figure below. Other configurations such as three, five, and higher numbered star wheel systems are contemplated alternative embodiments or extensions of this invention.

The presentation herein about thrust levitation reveals, explains, and predicts new break-through concepts and technical innovations that make possible and foretell an exciting and bountiful future exploring the universe and living in space. The new opportunities that are foretold are based on a fundamental new understanding of physics that allows thrust levitation propulsion systems and technologies to be developed. The concepts and technologies presented and explained convert energy to thrust drive and are used in order to develop system analyses that are based on torque to force vector analysis derivations.

In summary, the use of star wheel designs and other similar configurations are considered to be obvious extensions of and to be simple geometric configuration variations of the concepts and features that are analyzed in this disclosure; and, therefore such disk rotor or bob rotor mechanisms are being claimed as part of this invention. The full development and rigorous description of the attributes of such systems, although obvious to a practitioner of thrust levitation technology, will become apparent to those skilled in the art upon a reading of the disclosure herein.

### BRIEF DESCRIPTION OF DRAWINGS

FIG. 1 is a schematic plan view of one form of a star wheel main rotor configuration using the teachings of this invention;

FIG. 2 is a top or plan view of a single shaft thrust levitation system;

FIG. 3 is a side elevational view of the apparatus shown in FIG. 2;

FIG. 4 is a conceptual perspective view of one form of the lifting disc and its drive mechanism used as a part of the apparatus shown in FIG. 2;

FIG. 5 is a first alternative structure for the lifting disc rotor and drive;

FIG. 6 is another embodiment of the lifting disc rotor and drive:

FIG. 7 is a schematic side elevational view of a thrust levitation transport vehicle.

### BEST MODE FOR CARRYING OUT THE INVENTION

A vehicle with a free wheeling main rotor system that uses a star wheel main rotor design can be implemented with either prop and bob rotor configurations or with conceptually simpler disk rotor configurations. The advantage of using prop and bob rotors is that the vehicle control systems that are required, in comparison to disk rotors, use simpler vehicle subsystem designs that are more comparable in complexity to the control systems that are used in general aviation aircraft.

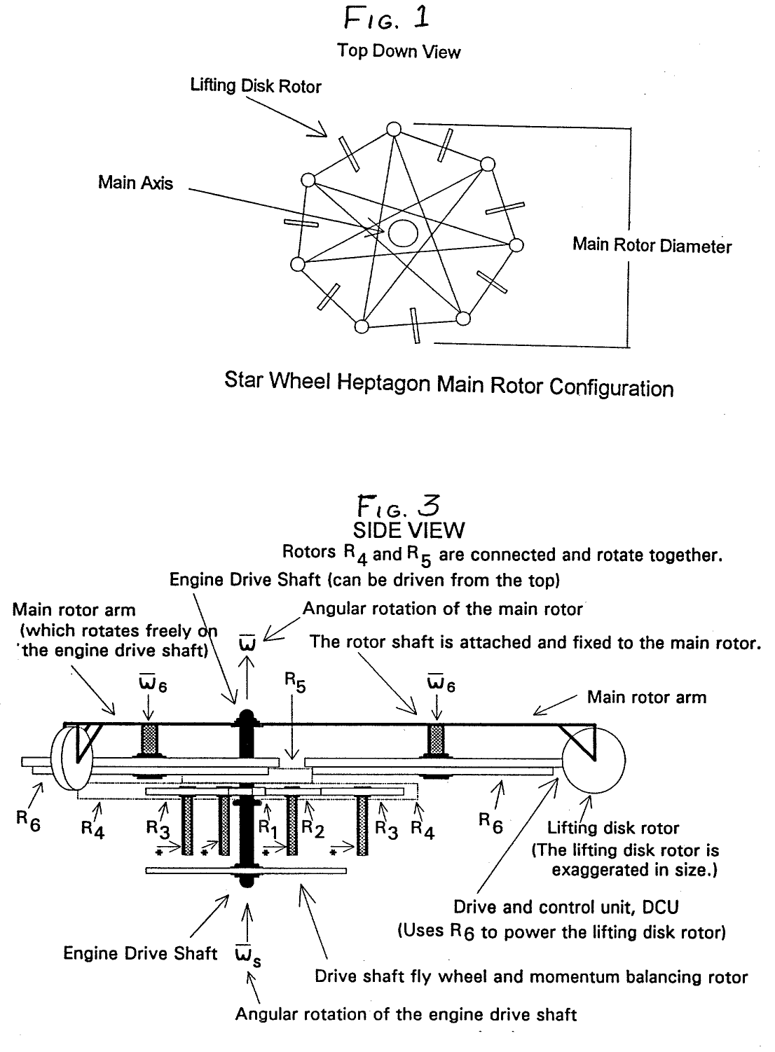

The advantages of star wheel type main rotor systems are that the geometry is amenable to simple construction. For the seven sided star wheel heptagon main rotor configuration, as is shown in FIG. 1, seven straight structural members are used, which cross the main rotor near the center of the main rotor axis by passing right next to the edge of the axis through the center of the main rotor.

A main rotor design implemented, for example, with disk rotors that are offset from the vertical by pitch angle rotations about the main rotor arms would yield a reactive component of torque about the axis of the main rotor that would drive the free wheeling main rotor. The only power required would be the power needed to drive the disk rotors; or the prop rotors if prop-bob rotors were used.

Another interesting attribute and feature of this invention is that when the rotational axis is vertical, the sum of the angular momentum vectors of all of the driven disk rotors acting together yields a vertical component of angular momentum in the downward direction which totally balances the upward directed angular momentum of the free wheeling main rotor. This vehicle total angular momentum balancing attribute is also available for prop-bob rotor designs. Notice that for a thrust levitation vehicle, it is usually necessary or at least helpful to zero out the vehicle total angular momentum vector so that the vehicle can maneuver without being constrained by the effects of a vehicle non zero total angular momentum vector.

This invention contemplates using prop rotors and bob rotors in order to provide the angular momentum that is required to control and maintain the vehicle total angular momentum at a value of zero. The technique involves using bob rotor systems on a single main rotor configuration that are configured appropriately by using pitch angle values for the bob rotors, powered by either driven torque or reactive torque, such that the bob rotors provide the required balancing angular momentum. Also, the prop rotors provide the required vehicle thrust levitation. Such prop and bob rotor configurations are readily constructed once an optimized design has been defined.

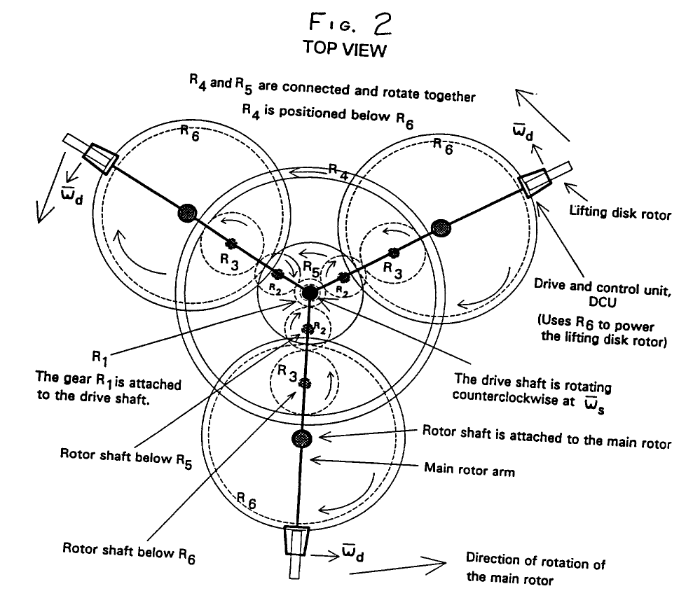

The thrust levitation mechanism shown in the drawings and equivalents thereof may be driven by a single drive shaft. In FIG. 2, there is seen a central drive shaft rotating in the counterclockwise direction at an angular rate \tilde{ω}ₛ. The lifting disc rotors are rotating in a right hand sense in the directions \tilde{ω}_{d}. The drive shaft gear is labeled R₁ and is rotating at the angular rate of \tilde{ω}ₗ, \tilde{ω}ₗ=\tilde{ω}ₛ. The other gears are labeled R₂ through R₆ and are rotating at the angular rates of \tilde{ω}₂ to \tilde{ω}₆ respectively. The main rotor is rotating in the counterclockwise direction at an angular rate of \tilde{ω}. If the quantities R₁ to R₆ are the gear radii, then the relationships between the radii and the angular rates are given by the following expressions:

$$\begin{matrix}{ω}_{6} = \frac{{R}_{5}}{{R}_{6}} \cdot {ω}_{5} \\ {ω}_{5} = {ω}_{4}\end{matrix}$$

since this is one wheel with two different gear surfaces at two different radii.

$$\begin{matrix}{ω}_{4} = \frac{{R}_{3}}{{R}_{4}} \cdot {ω}_{3} \\ {ω}_{3} = \frac{{R}_{2}}{{R}_{3}} \cdot {ω}_{2} \\ {ω}_{2} = \frac{{R}_{1}}{{R}_{2}} \cdot {ω}_{1}\end{matrix}$$

ω₁ is the angular rate of the driven drive shaft.

Therefore,

$$\begin{matrix}{ω}_{6} = \frac{{R}_{5}}{{R}_{6}} \cdot \frac{{R}_{3}}{{R}_{4}} \cdot \frac{{R}_{2}}{{R}_{3}} \cdot \frac{{R}_{1}}{{R}_{2}} \cdot {ω}_{1} \\ {ω}_{6} = \frac{{R}_{5}}{{R}_{6}} \cdot \frac{{R}_{1}}{{R}_{4}} \cdot {ω}_{1} .\end{matrix}$$

which reduces to

The relationship between ω and ω₆ is a function of the conservation of the angular momentum of the rotors, energy efficiency of the mechanism, and the balance of the drive shaft torque and the opposing torque produced by the lifting disk rotors.

Typically, for example, ω=0.216·Ω₆.

In the example below Figure 31, the approximate gear ratios are

$${ω}_{6} = \frac{3.37}{6.13} \cdot \frac{1.00}{8.33} \cdot {ω}_{1}$$

which reduces to ω₆=0.0660·ω₁. Therefore if ω₁ is 2100 rpm then ω₆ is 139 rpm and ω is 30 rpm. Typically the gear ratio used to drive the lifting disk rotors is such that the lifting disk rotors would be, for example, rotating at 500 rpm, ω_{d}=500 rpm.

The performance of the system can be easily adjusted since the design radii of the gears R₅ and R₆ can be adjusted over a significant range of values. For example, R₅ could be reduced by about 30% and could be increased by about 14%. This would change the relationship between \tilde{ω}₆ and \tilde{ω}₁ to \tilde{ω}₆=0.0313·\tilde{ω}₁. Then, ignoring the increased angular momentum effects, the corresponding values of \tilde{ω}₁, \tilde{ω}₆, \tilde{ω}, and \tilde{ω}_{d} become 2100 rpm, 85 rpm, 18 rpm, and 300 rpm respectively. The value of \tilde{ω}, the angular rate of the main rotor in the counterclockwise direction, would probably be somewhat higher than 18 rpm because of the increased size of R₆. Likewise, the angular rate of the lifting disk rotors, i. e. the value for \tilde{ω}_{d} of 300 rpm, would be decreased somewhat (because the total power available would still be the same). Also, referring to FIG. 2, \tilde{ω}_{d} could be decreased by changing the drive and control unit gear ratios.

An illustration of a thrust levitation mechanical configuration that is driven by a single drive shaft is represented by the data presented below:

| | | |
|---|---|---|
| Drive shaft gear | R₁ = 1.00 | |
| Primary rpm reduction gear | R₂ = 1.46 | |
| Secondary rpm reduction gear | R₃ = 2.18 | |
| Size reduction gear | R₄ = 8.33 | |
| Central drive gear | R₅ = 3.37 | |
| Drive rpm reduction gear | R₆ = 6.13 | |
| DCU drive gear | R₁ₒᵤₜₑᵣ = 6.67 | |
| Lifting disk rotor - Thickness = | Typically is 2·x_{dv} | Typically x_{dv} is |
| | | 2% of b |
| Lifting disk rotor - inner radius | = a | Typically a is |
| | | 92% to 94% of b |
| Lifting disk rotor - Outer radius | = b | Typically b is 4 |
| | | inches to 12 |
| | | inches |

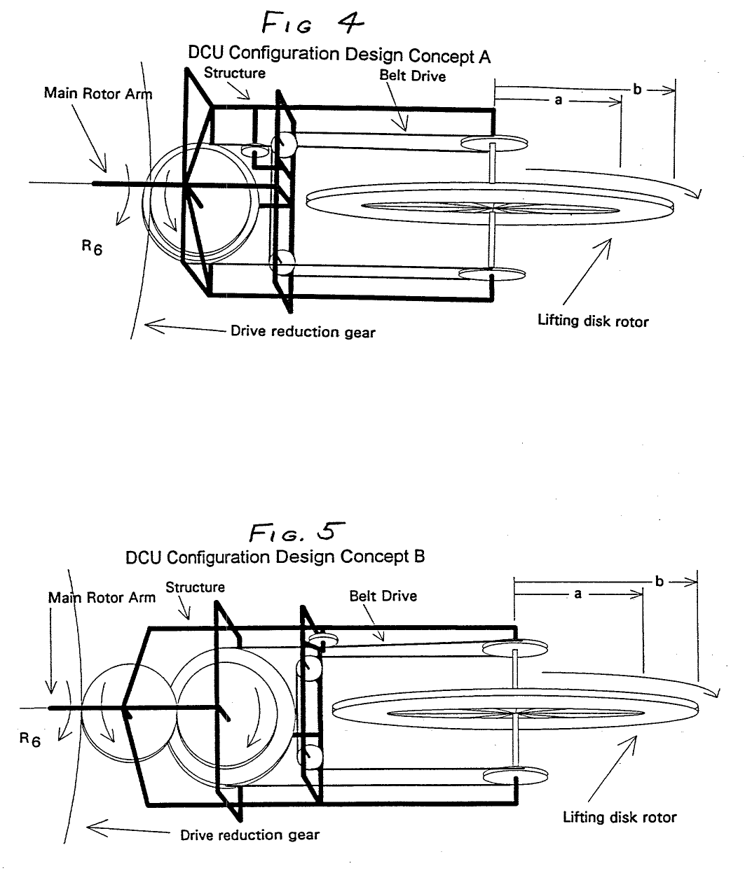

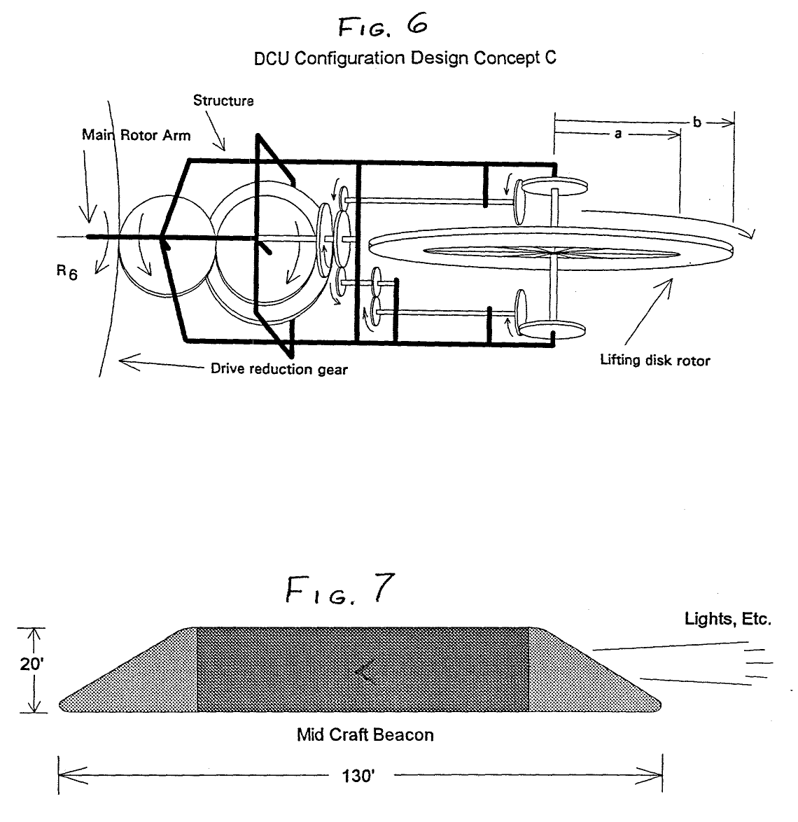

The complexities of the drive reduction unit configurations shown in FIGS. 3 to 6 are interesting because it appears that by increasing the complexity and sophistication of thrust levitation system designs that it is possible to increase the system reliability. For example, the belt designs in FIGS. 4 and 5 are likely to be less reliable than the more complicated gear design in FIG. 6.

Other design configurations that explore vertical and horizontal thrust levitation and vehicle controls are described, discussed, and developed in other parts of this disclosure. Vehicle horizontal thrust levitation and vehicle attitude control can be implemented, for example, by dynamically pivoting the Drive and Control Units (DCU) in a coordinated fashion about vertical axes that pass through each of the DCU units, as is discussed and developed elsewhere in this disclosure. Notice that the DCU units are attached to the main rotor which rotates in a counterclockwise direction at the rate of \tilde{ω}.

The system design configuration illustrated in FIGS. 2 and 3 is only one example of how a thrust levitation system could be constructed such that one drive shaft can be used in order to simultaneously power both the main rotor and the DCU units.

Variations of the design presented above could include the elimination of the rotor R₂ which would simplify the complexity of the design and which would at the same time cause the main rotor to rotate in a clockwise direction, i. e. change the direction of the vector \tilde{ω} by 180 degrees.

In order to fully understand the reasons why the single drive shaft can be used in order to drive the thrust levitation system mechanism while at the same time having the total torque of the system sum to zero and at the same time balancing the angular momentum of the system, it is necessary to refer to the mathematical physics analyses set forth below. In summary, the lifting disk rotors produce counter balancing torque that is opposite to and is equal to the torque that is used in order to drive the thrust levitation system with the vehicle drive shaft.

Another interesting design information detail is that the minimum number of DCU units and associated main rotor arms is considered to be three, as is illustrated in FIGS. 2 and 3. The number of DCU units could be increased from three to numbers such as 4, 10, 16, 36, 64, 72, et cetera. As the radius of the main rotor is increased then the number of DCU units, i. e. the number of lifting disk rotors, could be increased.

One of ordinary skill in the art will readily discern how to extend the thrust levitation system analyses and design approaches presented in this invention disclosure to new system configurations. For example, it is obvious how to merely apply the same mathematical and design technologies demonstrated in this invention disclosure to new system geometry configurations, i. e. new vehicle designs, and implement sophisticated vehicle design capabilities on high performance computer systems.

New vehicle designs could, for example, employs new vehicle geometry, varying dimensions and gross weights, varying and available power levels, and et cetera. Summarizing; the techniques, approaches, and methods that should be used in order to develop new system analyses and design capabilities for a new thrust levitation system are clear extensions of the methods that are presented and used in this invention disclosure. Although, for many new system configurations and situations, it is difficult to implement appropriate developmental methods and extend the thrust levitation system design and optimization approaches that are presented in this invention disclosure to the new configurations.

This invention disclosure presents a representative and a sample derivation for a thrust levitation system engineering analysis. These analyses and design approaches are used in order to assign values to vehicle design parameters, to numerically evaluate the performance of a vehicle design, and then to compute a propulsion performance efficiency value for the sample vehicle design. Many other similar system engineering analyses could be developed that are obvious, albeit much more complicated, extensions of the features and techniques that are presented in this invention disclosure.

The ability to predict the performance efficiency of proposed thrust levitation technology system designs is considered to be a valuable innovation and feature that is being claimed as part of this invention. This predictive performance feature is likely to make this invention unique from other similar inventions that might already exist, may be appearing concurrently with this invention disclosure, or that may be proposed in the future.

A representative vertical dynamics analysis that could be embellished with additional similar features and obvious extensions is presented below. This analysis could obviously be extended to a two or three dimensional analysis by implementing the features of, for example, a two dimensional thrust levitation vehicle that are described and characterized in this book. For example, some of these two and three dimensional design feature extensions are specifically described and discussed in this disclosure.

A representative thrust levitation power efficiency design analysis is included that could be implemented for more sophisticated thrust levitation vehicle designs by using obvious similar features and extensions of the approaches that are illustrated in FIGS. 1-6.

Thrust levitation propulsion, inertial field force beam systems, spacial warp system concepts, and system applications can be developed and designed that use and extend the concepts and systems outlined in this book.

The vehicle classes outlined in this invention disclosure include light weight and heavy weight vehicles. These vehicle classes are specifically intended to include the levitating automobile applications that are described.

Additionally, these classes can be extended to vehicle concepts such as various levitating automobiles and trucks, orbital space launch vehicles, space transit vehicles in order to support space trips within the Solar system, and other system concepts such as star ships by combining and extending the features that are characterized and described.

Notice that the inventors' theories concerning Cosmology when combined with thrust levitation technology make star ships possible and space transport operations within the Solar system technically practical in the near term and seemingly very cost effective. This is especially true when compared to the lowest cost 1996 public proposals for human trips to Mars and possibly even for return trips to the moon to take up where Apollo 11, during the first moon landing on Jul. 21, 1969, and the other Apollo missions left off.

A thrust levitation automobile vehicle class could be developed that would be able to operate just a few feet above a standard road. By properly extending the thrust levitation technology presented herein, a thrust levitation automobile could be designed that would be able to operate safely just above existing roads. Such a thrust levitation automobile would have positive control even in high cross wind conditions and would be able to operate in amongst heavy rush hour traffic on all city streets, interstate highways, and up and down the steepest mountainous roads and highways.

Individual vehicle types; such as the automobile application, the optimized space transit vehicle configuration and the nuclear thrust levitation vehicles described and characterized below are all intended to be provided with patent protection under the category of obvious extensions for this invention disclosure.

In summary, many other similar and significantly different applications can be envisioned that are within the scope and concepts disclosed herein.

The vehicle design configuration presented in section 5.6 and below has the attribute of being an optimized design for use as a thrust levitation space vehicle.

### The Enterprise Clipper

A suggested Plan Form Configuration for an intergalactic or at least interstellar vehicle is shown in FIG. 7. A smaller view is presented below:

[chemical structure]

Vehicle Performance Design Factors

The Enterprise Clipper design goal of providing cheap and easy access to space implicitly imposes requirements on a thrust levitation vehicle that include

An optimized single stage to orbit vehicle configuration

Notice that wings are simply an artifact from the first 50 years of aircraft development and are pure baggage for a thrust levitation vehicle. For a thrust levitation vehicle that ascends and descends from space at low speed by using engine power, the presence of wings are a vehicle structural mass and obstruction penalty in space, which directly reduce the on-board fuel capacity during low speed atmospheric operations, and finally which impose a maneuvering constraint on essentially all vehicle operations.

Low cost engine systems such as turbine engines and electric motors

Atmospheric air-breathing engines used in atmospheric operational conditions for long cruise range and for thrust levitation lift and forward thrust.

Reliable vertical ascent and decent capabilities relying totally on thrust levitation for lift and forward thrust for operation from conventional airports and from newly constructed operational sites as needed.

Some of the attributes of this craft are the ability to function as an Earth to space shuttle and launch vehicle and as a space transport ship. In the atmosphere and in space the symmetry design of the craft allows it to maintain a 1g₀ upward acceleration rate continuously and thereby maintain the crew in a comfortable shirt sleeve and 1g₀ gravitational type accelerated environment while in operation.

Other attributes include large effective frontal areas for sensor and viewing screens; an excellent outer hull shape for the discharge of electrical charge buildup and electrostatic fields; low effective frontal cross sectional area for very high speed transit in space and in the atmosphere; excellent forward operational capability in the atmosphere at low or high speed and at low altitude on approaches to and from unimproved landing sites; a convenient rectangular planiform for excellent maneuverability while levitating near the ground, just above the ground, and on the ground in amongst crowded ground facilities; and et cetera. Notice that this craft is able, because of its front to rear symmetry and upper craft or top symmetry, and is designed to travel vertically upward through the atmosphere or a gaseous region in space at a very high speed that is near the top speed of the craft while maintaining its stability and maintaining its vehicle attitude control.

This craft would be an extremely cost effective vehicle and an excellent vehicle design configuration choice for a Mars nuclear powered transport ship. Using the table information below, it is predicted that this ship could travel the roughly 2 to 3 au, astronomical units, of distance to Mars in about one week or slightly less time at a 1 g₀ rate of continuous ship acceleration and deceleration.

A trip from the surface of the Earth to the vicinity of Mars and then onward to the surface of Mars, and followed by a return trip to Earth, in this craft would be an exciting, comfortable, and safe experience. A trip to the moon in this craft would be an afternoon cruise.

The technique of combining thrust levitation propulsion and inertial field force beam system features in a single vehicle design can yield aerospace superiority vehicles that are capable of accelerating at very high rates while compensating the effective acceleration levels in the vehicle operational areas inhabited by the crew with traction and repulsion beams that maintain these crew quarters at comfortable 1 g₀ environmental levels.

The performance of the new technology, in terms of the power converted from vehicle engine system output power into thrust, is predicted by the analyses in this book to be easily capable of propelling a self contained and reusable vehicle from the surface of the earth into space (depending upon the particular overall system configuration, optimization, and parameter values that are implemented). In space, launch vehicles can be propelled efficiently with thrust levitation. The estimated and predicted mass fraction needed in order for a thrust levitation vehicle to reach an altitude of 500 miles in a time period of about 1 hour is 3% of the vehicle gross weight. The fuel that was used for these estimates is turbine fuel and both atmospheric and on-board oxygen. In summary, thrust levitation space launch vehicles are far superior in both technical and cost performance in comparison to current 1990s SSTO (single stage to orbit) launch vehicle technologies.

An alternative embodiment of this invention involves the use of an electronic implementation of thrust levitation that converts electrical power directly into vehicle thrust by using theoretical techniques that employ particle acceleration and/or possibly even super conductivity. One implementation would use toroidal coils that are rotating mechanically about the main axis of the torrid. It has been hypothesized by the inventors that such electronic system implementations, possibly using super conductivity, may be capable of receiving and transmitting gravity wave signals.

Electronic thrust levitation system approaches appear to be feasible and are likely to be simpler in design than the mechanical approaches for the configurations that were studied, but the efficiency of an electronic implementation is likely to be less than that of a mechanical system implementation.

A rotating toroidal coil that was powered with dc power was tested. This test was named the Gravity Wheel test in the test notes. A large toroidal coil (with a coil diameter of 3″ carefully rapped on a circular aluminum support tube attached to the rim of a 24 inch bicycle wheel which yielded a 13.5″ coil radius to the center of the toroidal coil) was mounted on the test fixtures. It was particularly interesting because test fixtures that were designed, built, and used for the test; the fact that attempts were made using electronic circuitry to detect and measure any received gravity wave field induced modulations that might have appeared on the dc current in the toroidal coil; and because attempts were made to detect any indications of thrust levitation effects by using the test fixtures that had been specifically constructed for this purpose. The results from this test were negative and inconclusive in the sense that no signal modulations nor thrust levitation effects could be detected.

The test was a success in the sense that the test equipment was constructed, and the concept of using superconductivity was considered but couldn't be implemented for this test, the test was carried out successfully and demonstrated how similar and future tests could be improved by redesigning the equipment and the test fixtures.

Electronic particle system thrust levitation systems, conceptually, could be implemented by using sophisticated driven plasma containment field systems.

A unique feature of thrust levitation driven plasma systems is that they wouldn't need to expel plasma gas into space as is done by a rocket in order to produce thrust. Also, conceivably, such plasma field systems could be designed to produce fusion and thereby provide the energy that would be needed in order to power a stellar star ship.

Conceptually, thrust levitation mechanisms can also be designed that use a mechanical main rotor and pumped liquids or gases in place of the lifting disk rotors.

By powering a thrust levitation system with nuclear power it appears that it would be possible and practical to make round trips throughout the Solar system.

Long inter stellar trips are expected to require nuclear materials that are not subject to radioactive decay since, although the crews onboard such trips are predicted to experience trip times of only weeks and months, the structure and outer components of the ships used for such missions might under some unforeseen situation be required to conceivably endure effective operational periods of millennium or more.

Time dilation effects acting on the structure of the ship shouldn't be a problem since the ship, according to the analyses and the author's understanding wont experience operational periods that are any longer than those experienced by the crew, although some of the ship structures will be required to endure the full warp speed acceleration levels, as defined in section 5.3. Never-the-less, shipboard nuclear power systems could or maybe should, if practical, use fusion power for stellar trips as opposed to fission power that relies on radioactive fuels with relatively short half lives in comparison to possible unexpectedly long effective ship structure mission times. Fission fuels could suffer half life degradation if long effective ship structure mission times should occur for some unexpected reason. Fission fuels such as plutonium with very long half lives might be appropriate if safely issued could be adequately addressed.

Nuclear thrust levitation space vehicles that are carrier class vehicles are envisioned that could be very large and roughly cylindrical shaped craft that would be capable of landing in the ocean, Great Lakes, and/or possibly even on land. Such craft, as envisioned, would be able to easily lift off from the earth and transit to space and then function in space as star ships. The size of such craft could, for example, be twice or three times the length of a Nimitz class aircraft carrier, say 1000 meters, and also comparably larger in volume, but much lighter in density and possibly comparable in weight, say 100,000 tons fully loaded.

Using TL design parameter handbook type data computed herein yields:

For a 90% efficient thrust levitation system the power requirements are

Climb power at 500 ft/minute=82,000 lbs/(3678 hp/0.90)=20.0 lbs/shp

Hover power=1 g₀ acceleration=82,000 lbs/(2386 hp/0.90)=30.9 lbs/shp

Warp 0.10=1 g₀ acceleration=30.9 lbs/shp

where shp is shaft horse power.

Thus a 100,000 ton craft that is capable of climbing at 500 ft/minute from sea level elevation would require at least 10 million shp available for thrust levitation. A TLS/CVN craft cooled carry a significant complement of space transit and aerospace superiority vehicles. Such large TLS/CVN craft would be able to operate at warp 0.1, i. e. low impulse power levels, which would be adequate for operations within the Solar system.

Therefore, a TLS/CVN craft weighing 100,000 tons that is capable of warp 0.1 is estimated to need 10 million shp, which may be possible on a very large ship since the propulsion systems could be distributed throughout the total area of the ship on, say for example, 154 different output power shafts. This requires less than 65,000 hp per shaft. Ship control could be accomplished by varying the power output on the different output power shafts. There would probably be an advantage in increasing the number of output power shafts to say 360, or even more, and thereby reducing the output power per shaft to about 28,000 shp or less.

Ideally, a TLS/CVN vehicle should be capable of warp speed operations, and use traction and repulsion force beam systems in order to maintain all crew quarter areas at comfortable 1 g₀ environmental levels. The 90% efficient warp 1 power requirement is:

Warp 1 acceleration=22 g₀ acceleration=(31 lbs /shp)/22 =1.41 lbs/shp

Since a 100,000 ton craft would take an excessive amount of power, it appears that only smaller craft can be expected to operate at warp speeds unless very efficient warp drive systems could be developed and even then extremely high output power would be required. For example, a 100,000 ton craft operating at warp 1 with 90% efficient thrust levitation would need 142 million shp. Possibly the advantage of being able to power a very large ship at warp speeds could someday be enough motivation in order to develop a warp drive system for such very large craft.

A high power warp drive system would seemingly require nuclear reactor systems that are, for instance, capable of powering a closed container thrust levitation mass acceleration system. Also, it' probable that such warp drive systems would have to operate at as close to 100% efficiency as possible in order to prevent them from over heating. Further, it seems likely that the high efficiency requirement would require electrical and mechanical systems such as super conducting motors and high temperature plasma systems that contain heat energy, are cooled by extracting energy with super conductors, and conceivably also use the particle mass and motion of the plasma in order to directly produce thrust levitation.

A small propulsion system that is capable of 10 million shp output is likely to be the first practical warp drive. For a craft to operate a warp 1 with a 10 million shp warp drive, the craft would have to have a gross weight of not more than about 7000 tons for a 90% efficient thrust levitation system. Smaller craft would be able to achieve higher warp speeds with 10 million shp.

It is estimated that a craft operating at 10 million shp continuously and at a speed of warp 1 would be capable of making a round trip from the Earth to a distance of roughly 60 light years from the Earth in about 40 months or 3.3 years, i. e. 3.3 years of time on the ship and also 3.3 years of time on the Earth since the crew quarters would be gravity compensated to 1 g₀. The ship would reach a maximum speed with respect to the Earth of about 38 c. This information is illustrated in Table 5-1b for v′/c=38 times the speed of light. Also, refer to Theoretical concept claim 55 for additional time-line details.

These estimates could be made by using the data set out below, and the TL design parameter values that are listed above. Therefore, assuming that the ship would have to lift its own weigh and climb from sea level by using thrust levitation mechanisms that are 90% efficient, then a minimum of 700,000 shp would be needed, 7000*2000/(20.0 lbs/shp). Additionally, at warp 1, according to Table 5-1a, the ship accelerates at about 22 gees, and therefore the power needed is 7000*2000/(1.41 lbs/shp) which, rounded up, yields 10 million shp.

The inventors propose that the class of thrust levitation Earth ships utilizing the technology disclosed and claimed herein be named Tory star ships or the “TORY” CLASS: Multi-purpose TL Space Ship Carriers (Nuclear Propulsion)(TLS/CVN).

The inventors present new theories, assertions, and claims about cosmology that directly support the patent claims about the capabilities of thrust levitation space craft throughout this disclosure. It is the intention of the inventors to support all of the theories, assertions, and claims made about cosmology with analyses and discussions. The inventors have included supportive analyses and supporting discussions together with references to the works of other authors and inventors that support the cosmological assertions that are presented.

When the thrust levitation technology that is being disclosed here is analyzed within the context of cosmology, then the inclusion of the new cosmological theories that are presented by the inventors are important in this book since they affect how thrust levitation technology applications can be implemented onboard space vehicles in order to allow high performance space craft and high speed space missions to be envisioned. Also, conversely, the implications of thrust levitation such as inertial field force beams affect and influence the formation of theories about cosmology.

The mathematical presentations below are considered as merely supportive of the cosmological assertions presented in this book and are not central or even directly supportive of the disclosure of thrust levitation technology. The mathematical physics presented in this invention disclosure are supportive of the cosmological theories that were postulated and derived from the inventors' analyses. In summary, the inventor's cosmology theories have helped the inventors envision and propose designs for space craft vehicle applications.

### The Correlation Theory of Relativity

The Correlation Theory of Relativity is a new cosmological theory that is being proposed by the inventors developed in order to support and explain the inertial field force beam claims and spacial warp claims included in this patent application. One of the fundamental postulates of the Correlation Theory of Relativity is that the acceleration of matter produces a field reactive response that is a gravitational wave. A gravitational wave carries an inertial field that has the same direction as the inertia of the accelerated matter that produced the gravitational wave. When a gravitational wave is incident on matter, then the inertia carried by the gravitational wave accelerates the matter in the direction of the inertial field carried by the gravitational wave.

Key points to keep in mind about the Correlation Theory of Relativity are that it is an extension of the Special and General theories of relativity and that it is in agreement with the predictions of both the Special and General theories of relativity.

The extended principle of equivalence that is defined in this invention disclosure states that if a system is within the traction beam compensated 1 g₀ environment provided onboard a craft that is accelerating at warp speeds, i. e. traveling at speeds in excess of say warp 0.1, which according to the definitions corresponds to a ship acceleration level of 1 g₀, then this compensated 1 g₀ system is physically equivalent to or identical to a system that is in a uniform gravitational field of strength 1 g₀g₀.

Another way of saying this is; that, the non inertial reference frame of the crew quarters that are always maintained at a 1 g₀ level on the accelerating ship and an inertial reference frame with a 1 gravitational field are equivalent. One of the important points about this physical equivalence is that the rate of the passage of time in these two systems is identical. Therefore, for example, the passage of time on the ship in the crew quarter areas would always be synchronized with the passage of time on the earth no matter how long or how far of a journey was undertaken by the ship.

A zero correlation sphere is a very distant spherical region about an object or an object with an observer, beyond which other objects have approximately zero correlation with respect to the observer. The significance of the relative correlation, or equivalently the spacial correlation, of objects is that the spacial correlation of objects is a measure of their relative speeds.

Objects in the vicinity of the zero correlation sphere that is associated with a reference location are normally very distant from this reference location and are objects that are traveling at speeds relative to an observer at the reference location that are typically greater than the speed of light. Objects that are beyond the zero correlation sphere from an observer can have a non-zero, although typically very small, probabilities of being on a path directed towards the observer and at relative speeds that exceed the speed of light. Generally as the relative speeds of objects increase, the probably that they are on intercept paths decrease and approach zero probability. Concurrently, the relative speeds of the object approach and exceed the speed of light.

High performance space missions are referred to in this book as inter dimensional space travel because the effective ship speeds exceed the speed of light even though the apparent speed of the ship never actually exceeds the speed of light as observed from the Earth, which can be considered to be nearly equivalent to a fixed inertial reference frame. The term inter dimensional space travel has been described by other authors as hyper-dimensional space travel; and, possibly such terms could be used interchangeably. As observed from the Earth, the speed of a ship would appear to, or would be computed to, always be less than the speed of light.

As observed from the Earth a high performance ship would appear to go from a visible object, to a visible pin point of light, and then to just totally disappear. In prior publications, this effect has been described as involving a ship or craft that appeared to have “pin-pointed out”.

The information and concepts presented in this invention disclosure could be described as the, or as a, definition for the meaning of inter dimensional space travel which involves warp speed space missions. The meaning and significant of warp speed is defined in subsequent claims for this patent.

The actual relative speed of the accelerating ship with respect to the Earth or any other inertial reference frame must be measured on the ship by computing the relative speed of the ship. The relative ship speed is computed by integrating the instantaneous acceleration of the ship over the passage of time as measured onboard the ship in the crew quarters.

The crew onboard a ship would compute that their speed quickly exceeded the speed of light and even exceeded many multiples of the speed of light. As a result, the ship and crew would be able to make interstellar trips of tens and even to hundreds of light year distances in mere months of onboard travel time; and, because of the acceleration compensated crew quarter environment onboard the ship, the crew would always be maintained at a 1 g₀ environmental level.

Since the crew on a ship would experience a travel time of mere months and since they would always be in a 1 g₀g₀ environment, the passage of time on the ship for the crew would be maintained in exact synchronization with and in step with the passage of time on the earth because the ship and earth would both have identical 1 g₀ environments.

The passage of time on the ship is not the computed Special Relativity time period because of the effect of maintaining the ship's crew quarters on the accelerating ship at 1 g₀ and because, relative to the Earth, the ship has pin-pointed our and is actually traveling inter dimensionally and relative to the Earth is effectively traveling faster than light speed.

Stellar space trips that effectively involve and implement inter dimensional space travel, i. e. faster than light speed trips on acceleration compensated crew quarter ships, can be accomplished by using nuclear powered thrust levitation systems, by accelerating the ship continuously at extremely high acceleration levels, and by compensating the crew quarter acceleration levels onboard the space ship such that the crew is comfortably maintained throughout their space journeys in 1 g₀ environments.

When a star ship crew arrives at a distance stellar location tens and even to hundreds of light years distance from the earth, then according to their onboard clocks they will have made an inter dimensional stellar trip in a period of time onboard the ship and also on the earth which is mere months in length. An observer on the ship and also an observer on the earth will conclude that the ship has effectively traveled across vast distances in space while the onboard crew did not age in accordance with the predictions of time dilation, but rather in accordance with inter dimensional space travel ship time.

A star ship crew would be able to spend a few weeks or months at their destination and then return to the earth again via inter dimensional travel and arrive back at the earth and still be in essentially exact age synchronization with their associates whom they left behind some months ago on the earth when they left on their trip. The effect is that the crew would have succeeded in having made an interstellar round trip to a star system tens and even to hundreds of light years distance from the earth during the passage of mere months of synchronized time onboard the ship, on the earth, and at their destination.

Our theoretical claim No. 53 concerns inter dimensional space travel equations. For the non-inertial frame of reference in which the ship is at rest, i. e. the prime coordinate system in which the ship is at rest at the coordinate system origin,

Speed v′_{c}·c=α′_{g}·g₀·t′ where v′=v′_{c}·c

Distance s′=½α′·t′² where α′=α′_{g}·g₀ and

g₀ is the acceleration of gravity at the surface of the Earth, for example,

g₀=32.174^{ft}/_{sec}_{²} or in SI (System International) units, g₀=9.80665^{m}/_{sec}_{²}

α′=C₀·g₀·W·10^{W/}^{₃}

C₀=9.26118728127 and W is the warp speed and W is defined on the ship.

In the un-primed fixed Earth coordinate system:

$$Acceleration a = {( 1 - \frac{{v}^{2}}{{c}^{2}} )}^{\frac{3}{2}} \cdot {a}^{′}$$

where α=α_{g}·g₀

$$Speed {v}_{c} \cdot c = c \cdot Tan h ( \frac{{a}_{g}^{′} \cdot {g}_{0} \cdot {t}^{′}}{c} )$$

where ν=ν_{c}·c

$$Distance s = \frac{{c}^{2}}{{a}_{g}^{′} \cdot {g}_{0}} \cdot [ Cos h ( \frac{{a}_{g}^{′} \cdot {g}_{0} {t}^{′}}{c} ) - 1 ]$$

or equivalently

$$s = \frac{{c}^{2}}{{a}_{g}^{′} \cdot {g}_{0}} \cdot [ \frac{1}{\sqrt{1 - \frac{{v}^{2}}{{c}^{2}}}} - 1 ]$$

$$Time t = \frac{c}{{a}_{g}^{′} \cdot {g}_{0}} Sin h ( \frac{{a}_{g}^{′} \cdot {g}_{0} \cdot {t}^{′}}{c} )$$

The expressions for s and t are approximations that are valid for values of v up to about 95 percent of c, the speed of light.

Table data information on the inter dimensional space travel time is presented below and is helpful in understanding and interpreting the significance of these equations. This table data was computed by using these equations. The values in the tables are computed for the specified onboard ship travel times, t′. The values listed in the tables are the corresponding computed values, for the passage of time on the Earth that are computed for the warp speed values W that are listed in the tables.

The interesting results presented in the tables by the data are the large distances s′ that can be traveled during the short ship travel times t′ that pass onboard the ship for the crew who are maintained in a 1 g₀ environment while the ship is traveling at the various warp speeds W that are listed in the tables.

The idea of warp speed is popular sci fi terminology today and is a concept that has been described functionally in science fiction writing and media programs. The Warp equation presented below was defined originally by the inventors for use in and by this invention and is considered to be a part of this invention and patent application. It was formulated by the inventors such that this mathematical definition is as consistent as possible with the popular speculations about space travel that have been presented by the current television program series Star Trek Voyager. This equation and the concept of warp, has proven to be a particularly convenient approach and provide a convenient parameter, W, for use in specifying the performance of a stellar ship over a very broad range of effective ship speeds and conditions, i. e. acceleration levels.

In Star Trek Voyager: Episode “Threshold”, Lieutenant Tom Paris crosses the trans Warp threshold barrier to Warp 10 in the shuttle craft Cockeran.

This episode was broadcast on the Seattle Washington channel 7 television station on Feb. 3, 1996, between 8:00 and 9:00 PM. During the episode, Captain Janeway, says about the trans warp drive “ . . . the Genie can't be put back into the bottle.” Also, during the episode, when the shuttle craft Cockeran reaches Warp 7, the critical Warp velocity, then a trans Warp drive is engaged by Lt. Paris in order to increase the velocity of the shuttle craft from Warp 7 up to the maximum Warp barrier between Warp 9.99 and Warp 10. As the shuttle craft increases it's speed beyond Warp 9.99 to Warp 10 then it is said to have crossed the trans Warp threshold. According to Lt. Paris during a conversation with Neelix, a velocity of Warp 10 is supposed to correspond to traveling at “infinite velocity”.

Warp, W as defined in this invention is a measure of acceleration that is defined by the warp equation. The warp number is defined in the range of 0≦W≦10, where a value of W=10 is not considered to be a physically realizable value, although the warp number, W, is an open ended scale that can, in a mathematical sense, exceed the value of 10.

Warp speed is an acronym or synonym for warp W and is defined as the operational speed envelope that is attained during acceleration at warp number W during any arbitrary period of time as measured onboard the accelerating vehicle in an acceleration compensated crew quarter area that is maintained at a 1 g₀ acceleration level.

The warp equation, which was originally defined herein, converts the warp number, W, into the acceleration, g, that is measured on the ship.

g=C₀·g₀·W·10^{W/}^{₃} where C₀ is a constant that is defined such that g=g₀ when the warp number is equal to 0.1, W=0.1 . This yields a value of C₀=9.26118728127. g₀ is the acceleration of gravity at the surface of the Earth, g₀=32.174^{ft}/_{sec}_{²} or in SI units, g₀=9.80665^{m}/_{sec}_{²}. An acceleration level of warp 10 is not considered to be physically realizable because of the extremely high stress levels that the structure of a craft would have to endure, although the warp number, W, is an open ended scale. At warp 7 g=13967·g₀. At warp 1 8.5 g=53631·g₀. At warp 8.6 g=58591·g₀. Craft warp speeds below warp 7 are

considered to be warp drive speeds and craft operations at and above warp 7 are considered to be operations at hyper warp speeds. Warp speeds of up to 8.5 to 8.6 are considered to be physically possible. Also, craft warp speeds that are below warp 1 are considered to be impulse speeds. Half impulse speed is warp 0.5 at which the craft acceleration is g=6.796782 g₀.

Notation Details

The notation used in the equations above is g=α′ and g=α′_{g}·g₀. In claim 67, α′ is used instead of g in the equations there for the acceleration of the ship that's measured on the ship.

Also, in Theoretical claim 67, α′_{g} is the acceleration of the ship that's measured on the ship in terms of gees, g₀. In Theoretical claim 67, the un-primed coordinate system corresponds to quantities that are measured in the fixed Earth coordinate system.

Another way of describing these notation differences is to say that if α′, which is the acceleration of the ship observed on the ship, were used in the equations above instead of g, then these equations would be consistent with the equations in Theoretical claim 67. Such details are minor and only have to be kept straight, but if a person were reviewing this information very carefully and was trying to understand these notation differences then it could be confessing and create concerns if these details weren't stated explicitly.

Stellar journeys could be made easily within the life spans of the crews onboard star ships by traveling at speeds above the speed of light as measured by the crews on stellar space ships. If the crews on these space ships were to return to their home worlds by traveling at near the speed of light as measured on their home worlds then, although as measured by the chronometer on-board the ship their en route time could be just months to a few years, still on their home worlds, because of time dilation effects, nearly a thousand years could elapse during their trip.

Such ambiguities that involve Einstein's Special and General theories of relativity are reviewed, analyzed, and investigated below in enough depth such that eventually and gradually they'll start to make sense and seem reasonable. Also, crews on ships traveling vast distances at average speeds that are less than or near the speed of light could or might choose to make one way trips and simply telemetry their reports back to their home worlds and continue on their journeys through space for their entire lives and make intermittent stops at points of interest.

To imagine the unimaginable, is to suspect and to postulate that speeds faster than the speed of light may be achievable by using advanced space travel concepts. In reality such speeds may be and even appear to be possible in theory as measured by and on-board a thrust levitation ship. The discussions in this chapter argue that these assertions are in complete accordance with the Special and General theories of relativity.

Also conceptual, empirical laboratory measurement data, and mathematical physics analyses exist that support the author's contentions about the possibility of achieving faster than light speeds. The inventors have included such information in this disclosure, including some analyses, and is requesting copyright and patent protection for this material even though it appears to the author that such information concerning Cosmology might be considered by some persons to be beyond the scope of these forms of protection.

Possibly it could be argued that these Cosmological concepts should be left out of this invention disclosure because of their complexity, the subjective interpretation required, and the somewhat superfluous significance of such information within the context of the subject of the most fundamental claimed capabilities of thrust levitation craft. The author chose to include the Cosmological concepts and claims in this book because leaving them out would have seriously detracted from the significance of this invention and would have prevented the author from discussing and including the significant thrust levitation designs and applications of advance space craft vehicles and prevented the author from requesting patent protection for many of these space based thrust levitation invention features and applications.

An example of empirical laboratory work, that can be interpreted to support the contentions that speeds near the speed of light and even way beyond are possible, includes the verified observations of how cosmic-rays produce the elementary negative meson particle and how this elementary particle then interacts in a manner that is inconsistent with the conventional, expected, and predicted behavior of the particle. In the discussion below about relativity, it is explained how exceeding the speed of light as measured, or more accurately described as computed, in the reference frame in which a star ship is at rest is entirely consistent with Einstein's theories of relativity.

The problem that has been encountered by theorists is that it is not possible to make a round trip over vast distances and return to the earth without having great periods of time elapse on the Earth during the trip because of time dilation. This passage of time, known as time dilation, occurs on the Earth because the speed of the ship as measured on the Earth is always less than the speed of light.

Recently, since about the spring of 1995, as a result of our efforts and success in understanding thrust levitation, we have extended Einstein's theories to include some new concepts that describe how thrust levitation technology can be used in order to eliminate the effects of time dilation. Our approach is to define a new supplemental theory called the Non Inertial Correlation Theory of Relativity or simply the Correlation theory of relativity.

The Correlation theory of relativity is summarized below and is developed mathematically. Some of the interesting aspects of the Special and General theories of relativity are also reviewed and developed. Key points to keep in mind are that the Correlation theory of relativity is an extension of the Special and General theories of relativity and is in agreement with the predictions of the Special and General theories of relativity. Because of the complexity of the concepts of the relativity theories and their complicated mathematical representations they may seem imposing when first encountered. Don't be intimidated by these theories since their affects can be understood without following through all of the complicated descriptions and reasoning that is associated with their developments. Also, ultimately these theories are actually simple and it is only their mathematical representations that can get complicated. Finally, in order to appreciate these theories it isn't necessary to follow all of the descriptions of the concepts involved or to understand all of the nuances of the mathematics.

A possible implication, of suspecting that the speed of light constraint can somehow be violated, is that particles retain a particle unique attribute of being able to be accelerated to speeds in free space, as computed in the frame of reference in which they are at rest, to speeds that are beyond the speed of light and of being able to exceed the speed of light in free space for indefinite periods of time. Notice that whenever the speed of a particle is measured from some inertial reference frame that then it will always be observed to be traveling less than the speed of light with respect to this inertial reference frame even if the relative speed of this particle is computed, from the frame of reference in which the particle is at rest, to be greater than the speed of light. This effect is referred to as the light speed paradox.

Conversely, when a particle is in the neighborhood of matter then the particle behaves as a wave and is constrained to travel at the maximum speed of a wave, i. e. at the speed of light in the matter through which it is traveling when near an atom. If the particle is traveling faster than the speed of light in matter then it radiates Cerenkov radiation when the particle approaches an atom. In free space a particle can travel faster than light speed as measured if its speed is clocked as it passes reference points or as computed in the rest frame of the particle since a high energy particle is behaving as a particle and is unconstrained by the speed of light, i. e. the maximum speed of a wave. These assertions are all ambiguous and are subject to interpretation and are deemed to be aspects of the light speed paradox.

The particle and wave duality nature of a high speed particle that is mentioned in the paragraphs above was rationalized as the dual particle-and-wave nature of matter and energy by a French physicist, Louis Victor Broglie (1892-1987). Broglie was the winner of the 1929 Nobel Prize in physics. Broglie made the following statement that appeared in “Pure and Applied Science,” a commentary appearing in the 1949 issue of the journal Research, Vol. 2, pp. 101-103 and is worth repeating:

“In this way the two aspects of science [pure and applied] correspond to the two principal activities of man: thought and action. They are inseparable if human science is to progress as a whole and fulfill with increasing success its high and twofold task.”

In this document Warp mechanics is the theory and analysis that is used in order to develop thrust levitation system analyses, the implementations and theories that allow levitation system generated impulse beams and traction beams to be used to accelerate the on-board cabin areas of a ship in order to maintain the crew areas of the ship at comfortable 1 acceleration levels, and the concepts that allow trust levitation ships to effectively travel at speeds faster than the speed of light between stellar destinations.

The engine systems that have been mentioned on the Star Trek Voyager 46 television series consist of Warp, Impulse, Thrusters, and Reaction Control System thrusters (RCS). Impulse drive speeds, as defined in this document, are used for slow speed operations and utilize low g ship acceleration levels, i. e. acceleration levels below 10 gees, Warp 0.6536. For impulse levels below about three gees it is unnecessary to compensate the acceleration levels of the onboard crew quarters with opposing traction beam forces in order to cancel out the acceleration levels of the ship. For ship acceleration levels significantly above three gees, i. e. at warp 1 and above, the crew quarters would be crushed if the compensating traction beam forces were not in continuous fail safe operation. Warp drive is high g drive acceleration that is accomplished by compensating the ship internal systems with opposing high acceleration traction beam forces such that the ship internal systems are maintained at a comfortable ship internal ambient vertical center line acceleration level of say, for example, 1 g₀.

Also, for a ship traveling vast distances over extended periods, provisions should be provided by the ship internal systems in order to automatically compensate for unusual, maneuvering, or transitory ship accelerations along the ship vertical center line and also in orthogonal or sideways directions. Simple ship designs for providing opposing acceleration forces could rely on a high mass ship design that would provide some protection against externally induced accelerations and then rely on ship attitude control in order to align the vertical center line axis properly to accommodate maneuvering acceleration, such as or similar to the banking attitude maneuvers that are used by modern aircraft today. More sophisticated ship board opposing acceleration traction beam force systems could be designed that would automatically sense and apply traction beam forces in order to compensate for suddenly applied and vertically directed and orthogonal sideways directed ship accelerations.

By using traction beam forces in order to compensate for high acceleration levels it should be possible, for instance, to accelerate a ship continuously at thrust levitation levels approaching and even exceeding 1600 gees, which is about warp 4.7. At such high levels of acceleration, the Special theory of relativity typically doesn't apply since the speed of the ship quickly approaches and essentially almost equals the speed of light as measured by an observer in an inertial reference frame. Notice that by definition an inertial reference frame is a frame of reference that is not accelerating. Equivalently, if in a reference system a free object does not experience any acceleration then that system is called an inertial frame of reference. Also, when the General theory of relativity is introduced in text books; then, typically, the introductory descriptions of General relativity ignore the effects of high g acceleration, the significance and subtle implications of time dilation, and the observation that a ship can attain speeds that exceed the speed of light by many factors as computed in the non inertial reference frame in which the ship is at rest. Typically, text books have included a problem at the end of a chapter on relativity that involves computing a distance traveled by a ship as measured on the Earth that is large enough such that when divided by the time of the trip as measured by the on-board crew that then the on-board crew would conclude that the speed of their ship had exceeded the speed of light.

Warp speed is defined as the operational speed envelope that is attained by a vehicle during acceleration at warp number W. Warp, W, is a measure of the acceleration level at which an aerospace vehicle is operating. The warp number, W, is defined in the range of 0≦W≦10, where a value of W=10 is not considered to be a physically realizable value, although the warp number, W, is an open ended scale that can, in a mathematical sense, exceed the value of 10.

Warp drive levels are defined as and correspond to the ship constant accelerations levels of from zero acceleration to 1 g₀ which corresponds to warp 0.1 by definition and to 13,967 g₀ at warp 7. Warp speeds above warp 7 are defined as hyper warp speeds by definition. Warp 10 is an acceleration level of 199564 g₀, that, by definition, is considered to be a physically non realizable acceleration level since it is believed that the structure of any conceivable vehicle that attempted to attain this acceleration level would fail structurally prior to reaching the acceleration level of warp 10. Notice that 1 g₀ is an acceleration level of 9.8066352 meters per second squared, which is roughly the average acceleration level of gravity at the surface of the Earth.

The correspondence between the rate at which a vehicle is accelerating and the warp speed at which a vehicle is traveling is specified by the warp equation. This equation converts the warp number, W, into acceleration. This mathematical function is defined by definition by the following equation:

α′=C₀g₀·W·10^{w/3}

where C₀ is a constant that is defined such that α′=g₀ when the warp number is equal to 0.1, W=0.1. This yields a value of C₀=9.26118728127. g₀ is the acceleration of gravity at the surface of the Earth, g₀=32.174 ft/sec² or in SI units, g₀=9.80665 m/sec².

Reiterating, an acceleration level of warp is not considered to be physically realizable because of the extremely high stress levels that the structure of a craft would have to endure at such high acceleration levels. Notice that the warp number, W, is an open ended scale. At warp 7 α′=13967·g₀. At warp 8.5 α′=53631·g₀. At warp 8.6 α′=58591·g₀. Also, craft warp speeds below warp 1 are considered to be impulse speeds. Half impulse speed is warp 0.5 at which g=6.796782·g₀, i. e. the ship is accelerating at 6.8 times the acceleration level of gravity at the surface of the Earth. Referring to Table 5-1a, another interesting detail about impulse speeds is that for the impulse speed level of warp 0.4 and below, the associated ship acceleration levels have the same g values times a factor of ten, i. e. 4. g₀ and for successively lower impulse warp levels respectively. Craft operations below warp 7 are considered to be warp drive speeds and craft operations at and above Warp 7 are considered to be hyper warp speeds. Warp speeds of up to 8.5 to 8.6 are considered to be physically possible.

For example, at warp 2.718 it is possible to travel from Earth orbit to about 100 astronomical units away and to come to roughly a full stop with respect to the Earth in about two earth days. Further, at warp 2.706, which corresponds to accelerating constantly at 200 g₀, it is possible to reach 49 astronomical units from the Earth in one earth day and to achieve a speed of 0.565 c as the ship passes the distance of 49 astronomical units from the Earth. Also, 49 astronomical units is about 10 astronomical units beyond the distance from the Sun to the planet Pluto. Close estimates for these dynamic parameter values can be obtained directly from Table 5-1a by interpolation.

Similarly, the mean distance of Mars from the Sun is about 1.52 astronomical units. Since Mars is typically less than 2.52 astronomical units from the Earth; then, referring to Table 5-2a, it is possible to travel to Mars and to come to a full stop in about six days at warp speeds of 0.06 to 0.10. Warp speeds of 0.06 to 0.10 correspond to constant acceleration levels of roughly 0.6 g₀ to 1 g₀. This means that by using constant acceleration levels of roughly 1 g₀ for six days, that it would be possible to use a thrust levitation ship in order to travel to Mars without having to have first developed the technology for a traction beam acceleration compensation system and without having first implemented such technology onboard a thrust levitation ship.

The data in the following tables present the speeds and distances that a thrust levitation ship can attain in one, three, 6.3 days, 15 days, 35 days, and in 2 and 20 months when accelerating at the warp speeds listed in these tables. The prime coordinate system values correspond to the speed and distance values measured and computed in the non-inertial reference frame in which the ship is at rest, i. e. the frame of reference that is attached to the ship and that is accelerating with the ship. The un primed coordinate system values correspond to the prime coordinate system values, but are measured in, for instance, the fixed Earth inertial reference frame. Notice that a non-inertial reference frame is one that is being accelerated whereas an inertial reference frame is one that is not being accelerated, but rather that is moving with a constant velocity in space. In the strictest sense, the Earth is undergoing acceleration since it is in orbit around the Sun and, as a result, is being accelerated by the gravity of the Sun. Notice that one astronomical unit, au, is the distance of the Earth from the Sun and that it takes light 8 minutes and 19.00 seconds to travel from the Sun to the Earth (at the speed of light). In the tables below, the ship speed is the speed that is attained by a thrust levitation ship after having accelerated at a′ for the period of time t′. The distance s′ is how far the ship has traveled after having accelerated constantly at a′ for the period t′. The time t is the period of time as measured on the Earth that has elapsed during the time t′ which is measured on-board the accelerating ship in the non-inertial reference frame that is attached to the ship.

The values in the following tables 5-1 to 5-7 are computed for the specified onboard ship travel times, t′. The values listed in the tables are the corresponding computed values, t, for the passage of time on the Earth that are computed for the warp speed values W that are listed in the tables. The interesting results presented in the tables by the data are the large distances s′ that can be traveled during the short ship travel times t′ that pass onboard the ship when the ship is traveling at the various warp speeds W that are listed in the tables. Also, notice that the travel times t′ that pass onboard the ship are synchronized with Earth time when the crew quarter areas are gravity compensated to 1 g₀.

TABLE 5-1a
Ship time: t′ = 1 day

| | Warp | Ship | Ship | Ship | Earth | Earth | Earth | Earth |
|---|---|---|---|---|---|---|---|---|
| | Speed | Accel | c Factor | Distance | Accel | c Factor | Distance | Time |
| Symbols: | W | a′/g₀ | v′/c | s′ | a/g₀ | v/c | s | t |
| Units: | | | | au | | | au | days |
| | 0.005 | 0.05 | 0.0001 | 0.011 | 0.046 | 0.00013 | 0.011 | 1.000 |
| | 0.01 | 0.09 | 0.0003 | 0.023 | 0.093 | 0.00026 | 0.023 | 1.000 |
| | 0.02 | 0.19 | 0.0005 | 0.046 | 0.188 | 0.00053 | 0.046 | 1.000 |
| | 0.03 | 0.28 | 0.0008 | 0.070 | 0.284 | 0.00080 | 0.070 | 1.000 |
| | 0.04 | 0.38 | 0.0011 | 0.093 | 0.382 | 0.0011 | 0.093 | 1.000 |
| | 0.05 | 0.48 | 0.0014 | 0.118 | 0.481 | 0.0014 | 0.118 | 1.000 |
| | 0.06 | 0.58 | 0.0016 | 0.142 | 0.582 | 0.0016 | 0.142 | 1.000 |
| | 0.07 | 0.68 | 0.0019 | 0.167 | 0.684 | 0.0019 | 0.167 | 1.000 |
| | 0.08 | 0.79 | 0.0022 | 0.193 | 0.788 | 0.0022 | 0.193 | 1.000 |
| | 0.09 | 0.89 | 0.0025 | 0.219 | 0.893 | 0.0025 | 0.219 | 1.000 |
| | 0.10 | 1.00 | 0.0028 | 0.245 | 1.000 | 0.0028 | 0.245 | 1.000 |
| | 0.29 | 3.38 | 0.0096 | 0.827 | 3.379 | 0.010 | 0.827 | 1.000 |
| | 0.48 | 6.49 | 0.018 | 1.587 | 6.485 | 0.018 | 1.587 | 1.000 |
| | 0.68 | 10.5 | 0.030 | 2.568 | 10.48 | 0.030 | 2.569 | 1.000 |
| | 0.87 | 15.6 | 0.044 | 3.820 | 15.57 | 0.044 | 3.821 | 1.000 |
| | 1.06 | 22.1 | 0.062 | 5.405 | 21.96 | 0.062 | 5.407 | 1.001 |
| | 1.25 | 30.2 | 0.085 | 7.396 | 29.90 | 0.085 | 7.400 | 1.001 |
| | 1.44 | 40.4 | 0.11 | 9.882 | 39.61 | 0.114 | 9.892 | 1.002 |
| | 1.63 | 53.0 | 0.15 | 12.97 | 51.26 | 0.149 | 12.99 | 1.004 |
| | 1.83 | 68.6 | 0.19 | 16.79 | 64.88 | 0.192 | 16.84 | 1.006 |
| | 2.02 | 87.8 | 0.25 | 21.49 | 80.16 | 0.243 | 21.60 | 1.010 |
| | 2.21 | 111.4 | 0.31 | 27.27 | 96.26 | 0.305 | 27.49 | 1.017 |
| | 2.40 | 140.3 | 0.40 | 34.33 | 111.5 | 0.377 | 34.78 | 1.026 |
| | 2.59 | 175.5 | 0.50 | 42.95 | 123.1 | 0.459 | 43.84 | 1.042 |
| | 2.78 | 218.4 | 0.62 | 53.44 | 127.5 | 0.549 | 55.15 | 1.065 |
| | 2.98 | 270.4 | 0.76 | 66.17 | 121.2 | 0.644 | 69.45 | 1.100 |
| | 3.17 | 333.5 | 0.94 | 81.60 | 103.3 | 0.736 | 87.82 | 1.155 |
| | 3.36 | 409.7 | 1.16 | 100.3 | 76.60 | 0.820 | 112.0 | 1.239 |
| | 3.55 | 501.8 | 1.42 | 122.8 | 48.05 | 0.889 | 144.8 | 1.371 |
| | 3.74 | 612.7 | 1.73 | 149.9 | 24.78 | 0.939 | 191.3 | 1.580 |
| | 3.93 | 746.2 | 2.11 | 182.6 | 10.22 | 0.971 | 261.1 | 1.925 |
| | 4.13 | 906.6 | 2.56 | 221:8 | 3.270 | 0.988 | 373.1 | 2.515 |
| | 4.32 | 1099. | 3.11 | 268.9 | 0.784 | 0.996 | 568.0 | 3.588 |
| | 4.51 | 1330. | 3.76 | 325.4 | 0.135 | 0.999 | 942.2 | 5.701 |
| | 4.70 | 1606. | 4.54 | 393.0 | 0.016 | 1.000 | 1748. | 10.31 |

TABLE 5-1b
Ship time: t′ = 1 day

| | Warp | Ship | Ship | Ship | Earth | Earth | Earth | Earth |
|---|---|---|---|---|---|---|---|---|
| | Speed | Accel | c Factor | Distance | Accel | c Factor | Distance | Time |
| Symbols: | ws | a′/g₀ | v′/c | s′ | a/g₀ | v/c | s | t |
| Units: | | | | au | | | light years | years |
| | 4.60 | 1455. | 4.11 | 355.9 | 0.05 | 0.999 | 0.0197 | 7.4 days |
| | 4.76 | 1700. | 4.80 | 415.9 | 0.01 | 1.000 | 0.0342 | 13. days |
| | 4.92 | 1984. | 5.61 | 485.6 | 0.00 | 1.000 | 0.0661 | 24. days |
| | 5.08 | 2314. | 6.54 | 566.2 | 0.00 | 1.000 | 0.145 | 53. days |
| | 5.24 | 2696. | 7.62 | 659.6 | 0.00 | 1.000 | 0.366 | 134 days |
| | 5.39 | 3138. | 8.87 | 767.8 | 0.00 | 1.000 | 1.10 | 1.10 |
| | 5.55 | 3649. | 10.31 | 892.8 | 0.00 | 1.000 | 4.00 | 4.00 |
| | 5.71 | 4240. | 11.98 | 1037.5 | 0.00 | 1.000 | 18.29 | 18.29 |
| | 5.87 | 4923. | 13.91 | 1204.5 | 0.00 | 1.000 | 108.5 | 108.5 |
| | 6.03 | 5712. | 16.14 | 1397.5 | 0.00 | 1.000 | 869.3 | 869.3 |
| | 6.19 | 6622. | 18.72 | 1620.3 | 0.00 | 1.000 | 9828.9 | 9828.9 |
| | 6.35 | 7673. | 21.69 | 1877.4 | 0.00 | 1.000 | 165217. | 165217. |
| | 6.51 | 8884. | 25.11 | 2173.8 | | | | |
| | 6.66 | 10281. | 29.06 | 2515.6 | | | | |
| | 6.82 | 11891. | 33.61 | 2909.5 | | | | |
| | 6.98 | 13745. | 38.85 | 3363.2 | | | | |
| | 7.14 | 15881. | 44.88 | 3885.6 | | | | |
| | 7.30 | 18339. | 51.83 | 4487.0 | | | | |
| | 7.46 | 21167. | 59.82 | 5179.0 | | | | |
| | 7.62 | 24420. | 69.02 | 5975.1 | | | | |
| | 7.78 | 28162. | 79.59 | 6890.5 | | | | |
| | 7.94 | 32462. | 91.75 | 7942.8 | | | | |
| | 8.09 | 37405. | 105.7 | 9152.1 | | | | |
| | 8.25 | 43084. | 121.8 | 10542. | | | | |
| | 8.41 | 49606. | 140.2 | 12137. | | | | |
| | 8.57 | 57096. | 161.4 | 13970. | | | | |
| | 8.73 | 65693. | 185.7 | 16074. | | | | |
| | 8.89 | 75560. | 213.6 | 18488. | | | | |
| | 9.05 | 86882. | 245.6 | 21258. | | | | |
| | 9.21 | 99869. | 282.3 | 24436. | | | | |
| | 9.36 | 114763. | 324.4 | 28080. | | | | |
| | 9.52 | 131841. | 372.6 | 32258. | | | | |
| | 9.68 | 151418. | 427.9 | 37048. | | | | |
| | 9.84 | 173855. | 491.4 | 42538. | | | | |
| | 10.00 | 199564. | 564.0 | 48829. | | | | |

TABLE 5-2a
Ship time: t′ = 3 days

| | Warp | Ship | Ship | Ship | Earth | Earth | Earth | Earth |
|---|---|---|---|---|---|---|---|---|
| | Speed | Accel | c Factor | Distance | Accel | c Factor | Distance | Time |
| Symbols: | W | a′/g₀ | v′/c | s′ | a/g₀ | v/c | s | t |
| Units: | | | | au | | | au | days |
| | 0.005 | 0.046 | 0.0004 | 0.102 | 0.05 | 0.0004 | 0.102 | 3.000 |
| | 0.01 | 0.093 | 0.0008 | 0.206 | 0.09 | 0.0008 | 0.206 | 3.000 |
| | 0.02 | 0.19 | 0.0016 | 0.414 | 0.19 | 0.0016 | 0.414 | 3.000 |
| | 0.03 | 0.28 | 0.0024 | 0.626 | 0.28 | 0.0024 | 0.626 | 3.000 |
| | 0.04 | 0.38 | 0.0032 | 0.841 | 0.38 | 0.0032 | 0.841 | 3.000 |
| | 0.05 | 0.48 | 0.0041 | 1.060 | 0.48 | 0.0041 | 1.060 | 3.000 |
| | 0.06 | 0.58 | 0.0049 | 1.281 | 0.58 | 0.0049 | 1.281 | 3.000 |
| | 0.07 | 0.68 | 0.0058 | 1.506 | 0.68 | 0.0058 | 1.506 | 3.000 |
| | 0.08 | 0.79 | 0.0067 | 1.735 | 0.79 | 0.0067 | 1.735 | 3.000 |
| | 0.09 | 0.89 | 0.0076 | 1.967 | 0.89 | 0.0076 | 1.967 | 3.000 |
| | 0.10 | 1.00 | 0.0085 | 2.202 | 1.00 | 0.0085 | 2.202 | 3.000 |
| | 0.29 | 3.38 | 0.029 | 7.442 | 3.38 | 0.029 | 7.442 | 3.000 |
| | 0.48 | 6.49 | 0.055 | 14.29 | 6.46 | 0.055 | 14.29 | 3.002 |
| | 0.68 | 10.5 | 0.09 | 23.12 | 10.37 | 0.089 | 23.13 | 3.004 |
| | 0.87 | 15.6 | 0.13 | 34.38 | 15.21 | 0.132 | 34.43 | 3.009 |
| | 1.06 | 22.1 | 0.19 | 48.64 | 20.96 | 0.185 | 48.79 | 3.018 |
| | 1.25 | 30.2 | 0.26 | 66.56 | 27.42 | 0.251 | 66.93 | 3.033 |
| | 1.44 | 40.4 | 0.34 | 88.93 | 33.99 | 0.330 | 89.81 | 3.059 |
| | 1.63 | 53.0 | 0.45 | 116.7 | 39.53 | 0.421 | 118.7 | 3.102 |
| | 1.83 | 68.6 | 0.58 | 151.1 | 42.40 | 0.524 | 155.4 | 3.172 |
| | 2.02 | 87.8 | 0.74 | 193.4 | 40.88 | 0.632 | 202.5 | 3.285 |
| | 2.21 | 111.4 | 0.94 | 245.4 | 34.33 | 0.737 | 264.2 | 3.467 |
| | 2.40 | 140.3 | 1.19 | 309.0 | 24.25 | 0.830 | 347.2 | 3.759 |
| | 2.59 | 175.5 | 1.49 | 386.5 | 13.92 | 0.903 | 463.4 | 4.237 |
| | 2.78 | 218.4 | 1.85 | 480.9 | 6.28 | 0.952 | 635.0 | 5.034 |
| | 2.98 | 270.4 | 2.29 | 595.5 | 2.16 | 0.980 | 906.7 | 6.413 |
| | 3.17 | 333.5 | 2.83 | 734.4 | 0.55 | 0.993 | 1374. | 8.936 |
| | 3.36 | 409.7 | 3.47 | 902.3 | 0.10 | 0.998 | 2265. | 13.92 |
| | 3.55 | 501.8 | 4.25 | 1105. | 0.011 | 1.000 | 4177. | 24.82 |
| | 3.74 | 612.7 | 5.19 | 1349. | 0.001 | 1.000 | 8916. | 52.07 |
| | 3.93 | 746.2 | 6.33 | 1643. | 0.000 | 1.000 | 2.3E + 04 | 132.6 |
| | 4.13 | 906.6 | 7.69 | 1996. | | | | |
| | 4.32 | 1099. | 9.32 | 2420. | | | | |
| | 4.51 | 1330. | 11.28 | 2928. | | | | |
| | 4.70 | 1606. | 13.62 | 3537. | | | | |

TABLE 5-2b
Ship time: t′ = 3 days

| | | | | | | | | |
|---|---|---|---|---|---|---|---|---|
| | Warp | Ship | Ship | Ship | Earth | Earth | Earth | Earth |
| | Speed | Accel | c Factor | Distance | Accel | c Factor | Distance | Time |
| Symbols: | ws | a′/g0 | v′/c | s′ | a/g0 | v/c | s | t |
| Units: | | | | light years | | | light years | years |

| | | | |
|---|---|---|---|
| 4.60 | 1455. | 12.3 | 0.051 |
| 4.76 | 1700. | 14.4 | 0.059 |
| 4.92 | 1984. | 16.8 | 0.069 |
| 5.08 | 2314. | 19.6 | 0.081 |
| 5.24 | 2696. | 22.9 | 0.094 |
| 5.39 | 3138. | 26.6 | 0.109 |
| 5.55 | 3649. | 30.9 | 0.127 |
| 5.71 | 4240. | 36.0 | 0.148 |
| 5.87 | 4923. | 41.7 | 0.171 |
| 6.03 | 5712. | 48.4 | 0.199 |
| 6.19 | 6622. | 56.1 | 0.231 |
| 6.35 | 7673. | 65.1 | 0.267 |
| 6.51 | 8884. | 75.3 | 0.309 |
| 6.66 | 10281. | 87.2 | 0.358 |
| 6.82 | 11891. | 100.8 | 0.414 |
| 6.98 | 13745. | 116.5 | 0.479 |
| 7.14 | 15881. | 134.6 | 0.553 |
| 7.30 | 18339. | 155.5 | 0.639 |
| 7.46 | 21167. | 179.5 | 0.737 |
| 7.62 | 24420. | 207.1 | 0.850 |
| 7.78 | 28162. | 238.8 | 0.981 |
| 7.94 | 32462. | 275.2 | 1.130 |
| 8.09 | 37405. | 317.1 | 1.302 |
| 8.25 | 43084. | 365.3 | 1.500 |
| 8.41 | 49606. | 420.6 | 1.727 |
| 8.57 | 57096. | 484.1 | 1.988 |
| 8.73 | 65693. | 557.0 | 2.287 |
| 8.89 | 75560. | 640.7 | 2.631 |
| 9.05 | 86882. | 736.7 | 3.025 |
| 9.21 | 99869. | 846.8 | 3.477 |
| 9.36 | 114763. | 973.1 | 3.996 |
| 9.52 | 131841. | 1117.9 | 4.591 |
| 9.68 | 151418. | 1283.8 | 5.272 |
| 9.84 | 173855. | 1474.1 | 6.054 |
| 10.00 | 199564. | 1692.1 | 6.949 |

TABLE 5-3a
Ship time: t′ = 6.3 days

| | Warp | Ship | Ship | Ship | Earth | Earth | Earth | Earth |
|---|---|---|---|---|---|---|---|---|
| | Speed | Accel | c Factor | Distance | Accel | c Factor | Distance | Time |
| Symbols: | W | a′/g0 | v′/c | s′ | a/g₀ | v/c | s | t |
| Units: | | | | au | | | au | days |
| | 0.005 | 0.046 | 0.0008 | 0.45 | 0.046 | 0.0008 | 0.451 | 6.300 |
| | 0.01 | 0.093 | 0.0017 | 0.91 | 0.093 | 0.0017 | 0.906 | 6.300 |
| | 0.02 | 0.19 | 0.0033 | 1.83 | 0.19 | 0.0033 | 1.827 | 6.300 |
| | 0.03 | 0.28 | 0.0051 | 2.76 | 0.28 | 0.0051 | 2.761 | 6.300 |
| | 0.04 | 0.38 | 0.0068 | 3.71 | 0.38 | 0.0068 | 3.710 | 6.300 |
| | 0.05 | 0.48 | 0.0086 | 4.67 | 0.48 | 0.0086 | 4.673 | 6.300 |
| | 0.06 | 0.58 | 0.0104 | 5.65 | 0.58 | 0.0104 | 5.651 | 6.300 |
| | 0.07 | 0.68 | 0.0122 | 6.64 | 0.68 | 0.0122 | 6.643 | 6.300 |
| | 0.08 | 0.79 | 0.0140 | 7.65 | 0.79 | 0.0140 | 7.651 | 6.300 |
| | 0.09 | 0.89 | 0.0159 | 8.67 | 0.89 | 0.0159 | 8.673 | 6.300 |
| | 0.10 | 1.00 | 0.018 | 9.71 | 1.00 | 0.0178 | 9.711 | 6.300 |
| | 0.29 | 3.38 | 0.060 | 32.82 | 3.36 | 0.0601 | 32.83 | 6.304 |
| | 0.48 | 6.49 | 0.12 | 63.01 | 6.36 | 0.1150 | 63.08 | 6.314 |
| | 0.68 | 10.5 | 0.19 | 101.9 | 9.96 | 0.1848 | 102.2 | 6.337 |
| | 0.87 | 15.6 | 0.28 | 151.6 | 13.93 | 0.2711 | 152.6 | 6.381 |
| | 1.06 | 22.1 | 0.39 | 214.5 | 17.62 | 0.3742 | 217.3 | 6.464 |
| | 1.25 | 30.2 | 0.54 | 293.5 | 19.96 | 0.4916 | 300.7 | 6.609 |
| | 1.44 | 40.4 | 0.72 | 392.2 | 19.72 | 0.6164 | 409.4 | 6.857 |
| | 1.63 | 53.0 | 0.94 | 514.8 | 16.37 | 0.7370 | 554.1 | 7.278 |
| | 1.83 | 68.6 | 1.22 | 666.4 | 10.94 | 0.8402 | 753.5 | 7.989 |
| | 2.02 | 87.8 | 1.56 | 853.1 | 5.66 | 0.9161 | 1042. | 9.202 |
| | 2.21 | 111.4 | 1.98 | 1082. | 2.19 | 0.9629 | 1487. | 11.328 |
| | 2.40 | 140.3 | 2.50 | 1363. | 0.61 | 0.9866 | 2236. | 15.230 |
| | 2.59 | 175.5 | 3.13 | 1705. | 0.12 | 0.9961 | 3632. | 22.90 |
| | 2.78 | 218.4 | 3.89 | 2121. | 0.01 | 0.9992 | 6.6E + 03 | 39.55 |
| | 2.98 | 270.4 | 4.82 | 2626. | 0.001 | 0.9999 | 1.4E + 04 | 80.70 |
| | 3.17 | 333.5 | 5.94 | 3239. | 0.000 | 1.0000 | 3.5E + 04 | 201.12 |
| | 3.36 | 409.7 | 7.30 | 3979. | 0.000 | 1.0000 | 1.1E + 05 | 636.24 |
| | 3.55 | 501.8 | 8.93 | 4873. | | | | |
| | 3.74 | 612.7 | 10.91 | 5950. | | | | |
| | 3.93 | 746.2 | 13.29 | 7246. | | | | |
| | 4.13 | 906.6 | 16.14 | 8804. | | | | |
| | 4.32 | 1099. | 19.57 | 10673. | | | | |
| | 4.51 | 1330. | 23.68 | 12914. | | | | |
| | 4.70 | 1606. | 28.60 | 15597. | | | | |

TABLE 5-3b
Ship time: t′ = 6.3 days

| | | | | | | | | |
|---|---|---|---|---|---|---|---|---|
| | Warp | Ship | Ship | Ship | Earth | Earth | Earth | Earth |
| | Speed | Accel | c Factor | Distance | Accel | c Factor | Distance | Time |
| Symbols: | ws | a′/g0 | v′/c | s′ | a/g0 | v/c | s | t |
| Units: | | | | light years | | | light years | years |

| | | | |
|---|---|---|---|
| 4.60 | 1455. | 25.9 | 0.223 |
| 4.76 | 1700. | 30.3 | 0.261 |
| 4.92 | 1984. | 35.3 | 0.305 |
| 5.08 | 2314. | 41.2 | 0.355 |
| 5.24 | 2696. | 48.0 | 0.414 |
| 5.39 | 3138. | 55.9 | 0.482 |
| 5.55 | 3649. | 65.0 | 0.560 |
| 5.71 | 4240. | 75.5 | 0.651 |
| 5.87 | 4923. | 87.7 | 0.756 |
| 6.03 | 5712. | 101.7 | 0.877 |
| 6.19 | 6622. | 117.9 | 1.017 |
| 6.35 | 7673. | 136.6 | 1.178 |
| 6.51 | 8884. | 158.2 | 1.364 |
| 6.66 | 10281. | 183.1 | 1.579 |
| 6.82 | 11891. | 211.7 | 1.826 |
| 6.98 | 13745. | 244.7 | 2.111 |
| 7.14 | 15881. | 282.8 | 2.439 |
| 7.30 | 18339. | 326.5 | 2.816 |
| 7.46 | 21167. | 376.9 | 3.250 |
| 7.62 | 24420. | 434.8 | 3.750 |
| 7.78 | 28162. | 501.4 | 4.324 |
| 7.94 | 32462. | 578.0 | 4.985 |
| 8.09 | 37405. | 666.0 | 5.744 |
| 8.25 | 43084. | 767.1 | 6.616 |
| 8.41 | 49606. | 883.3 | 7.617 |
| 8.57 | 57096. | 1016.6 | 8.768 |
| 8.73 | 65693. | 1169.7 | 10.088 |
| 8.89 | 75560. | 1345.4 | 11.603 |
| 9.05 | 86882. | 1547.0 | 13.341 |
| 9.21 | 99869. | 1778.2 | 15.336 |
| 9.36 | 114763. | 2043.4 | 17.623 |
| 9.52 | 131841. | 2347.5 | 20.245 |
| 9.68 | 151418. | 2696.1 | 23.251 |
| 9.84 | 173855. | 3095.6 | 26.697 |
| 10.00 | 199564. | 3553.3 | 30.645 |

TABLE 5-4a
Ship time: t′ = 15 days

| | Warp | Ship | Ship | Ship | Earth | Earth | Earth | Earth |
|---|---|---|---|---|---|---|---|---|
| | Speed | Accel | c Factor | Distance | Accel | c Factor | Distance | Time |
| Symbols: | ws | a′/g0 | v′/c | s′ | a/g0 | v/c | s | t |
| Units: | | | | light years | | | au | days |
| | 0.005 | 0.046 | 0.0 | 0.45 au | 0.046 | 0.0020 | 2.559 | 15.000 |
| | 0.01 | 0.093 | 0.0040 | 0.91 au | 0.093 | 0.0040 | 5.138 | 15.000 |
| | 0.02 | 0.19 | 0.0080 | 1.83 au | 0.188 | 0.0080 | 10.355 | 15.000 |
| | 0.03 | 0.28 | 0.0121 | 2.76 au | 0.284 | 0.0121 | 15.652 | 15.000 |
| | 0.04 | 0.38 | 0.0162 | 3.71 au | 0.382 | 0.0162 | 21.030 | 15.001 |
| | 0.05 | 0.48 | 0.0204 | 4.67 au | 0.481 | 0.0204 | 26.491 | 15.001 |
| | 0.06 | 0.58 | 0.0247 | 5.65 au | 0.581 | 0.0247 | 32.034 | 15.002 |
| | 0.07 | 0.68 | 0.0290 | 6.64 au | 0.683 | 0.0290 | 37.662 | 15.002 |
| | 0.08 | 0.79 | 0.0334 | 7.65 au | 0.786 | 0.0334 | 43.375 | 15.003 |
| | 0.09 | 0.89 | 0.0379 | 8.67 au | 0.891 | 0.0378 | 49.174 | 15.004 |
| | 0.10 | 1.00 | 0.0424 | 9.71 au | 0.997 | 0.0424 | 55.060 | 15.004 |
| | 0.29 | 3.38 | 0.1433 | 32.82 au | 3.277 | 0.1423 | 186.360 | 15.051 |
| | 0.48 | 6.49 | 0.2750 | 63.01 au | 5.800 | 0.2683 | 359.433 | 15.190 |
| | 0.68 | 10.5 | 0.4450 | 101.94 au | 7.872 | 0.4178 | 587.487 | 15.500 |
| | 0.87 | 15.6 | 0.6619 | 0.01359 | 8.45 | 0.580 | 891.444 | 16.120 |
| | 1.06 | 22.1 | 0.9365 | 0.01923 | 6.93 | 0.734 | 0.02071 y | 17.291 |
| | 1.25 | 30.2 | 1.2814 | 0.02631 | 4.14 | 0.857 | 0.03011 y | 19.455 |
| | 1.44 | 40.4 | 1.7121 | 0.03516 | 1.73 | 0.937 | 0.04461 y | 23.481 |
| | 1.63 | 53.0 | 2.2472 | 0.04614 | 0.48 | 0.978 | 0.06911 y | 31.225 |
| | 1.83 | 68.6 | 2.9090 | 0.05973 | 0.09 | 0.994 | 0.11571 y | 47.139 |
| | 2.02 | 87.8 | 3.7240 | 0.07647 | 0.01 | 0.999 | 0.21751 y | 83.390 |
| | 2.21 | 111.4 | 4.7243 | 0.09701 | 0.00 | 1.000 | 0.48101 y | 178.830 |
| | 2.40 | 140.3 | 5.9482 | 0.122 | 0.00 | 1.000 | 1.31551 y | 1.3 yr |
| | 2.59 | 175.5 | 7.4414 | 0.153 | 0.00 | 1.000 | 4.69981 y | 4.7 yr |
| | 2.78 | 218.4 | 9.2585 | 0.190 | 0.00 | 1.000 | 23.31 y | 23.3 yr |
| | 2.98 | 270.4 | 11.4647 | 0.235 | 0.00 | 1.000 | 170.71 y | 170.7 yr |
| | 3.17 | 333.5 | 14.1377 | 0.290 | 0.00 | 1.000 | 2E + 03 y | 2E + 03 yr |
| | 3.36 | 409.7 | 17.3701 | 0.357 | | | | |
| | 3.55 | 501.8 | 21.2719 | 0.437 | | | | |
| | 3.74 | 612.7 | 25.9742 | 0.533 | | | | |
| | 3.93 | 746.2 | 31.6329 | 0.650 | | | | |
| | 4.13 | 906.6 | 38.4328 | 0.789 | | | | |
| | 4.32 | 1099. | 46.5936 | 0.957 | | | | |
| | 4.51 | 1330. | 56.3760 | 1.158 | | | | |
| | 4.70 | 1606. | 68.0889 | 1.398 | | | | |

TABLE 5-4b
Ship time: t′ = 15 days

| | | | | | | | | |
|---|---|---|---|---|---|---|---|---|
| | Warp | Ship | Ship | Ship | Earth | Earth | Earth | Earth |
| | Speed | Accel | c Factor | Distance | Accel | c Factor | Distance | Time |
| Symbols: | ws | a′/g0 | v′/c | s′ | a/g0 | v/c | s | t |
| Units: | | | | light years | | | light years | years |

| | | | |
|---|---|---|---|
| 4.60 | 1455. | 61.7 | 1.266 |
| 4.76 | 1700. | 72.1 | 1.480 |
| 4.92 | 1984. | 84.1 | 1.728 |
| 5.08 | 2314. | 98.1 | 2.015 |
| 5.24 | 2696. | 114.3 | 2.347 |
| 5.39 | 3138. | 133.0 | 2.732 |
| 5.55 | 3649. | 154.7 | 3.177 |
| 5.71 | 4240. | 179.8 | 3.691 |
| 5.87 | 4923. | 208.7 | 4.286 |
| 6.03 | 5712. | 242.1 | 4.972 |
| 6.19 | 6622. | 280.7 | 5.765 |
| 6.35 | 7673. | 325.3 | 6.679 |
| 6.51 | 8884. | 376.6 | 7.734 |
| 6.66 | 10281. | 435.9 | 8.950 |
| 6.82 | 11891. | 504.1 | 10.351 |
| 6.98 | 13745. | 582.7 | 11.966 |
| 7.14 | 15881. | 673.2 | 13.824 |
| 7.30 | 18339. | 777.4 | 15.964 |
| 7.46 | 21167. | 897.3 | 18.426 |
| 7.62 | 24420. | 1035.3 | 21.258 |
| 7.78 | 28162. | 1193.9 | 24.515 |
| 7.94 | 32462. | 1376.2 | 28.259 |
| 8.09 | 37405. | 1585.7 | 32.562 |
| 8.25 | 43084. | 1826.5 | 37.505 |
| 8.41 | 49606. | 2103.0 | 43.183 |
| 8.57 | 57096. | 2420.5 | 49.702 |
| 8.73 | 65693. | 2785.0 | 57.187 |
| 8.89 | 75560. | 3203.3 | 65.776 |
| 9.05 | 86882. | 3683.3 | 75.632 |
| 9.21 | 99869. | 4233.8 | 86.937 |
| 9.36 | 114763. | 4865.3 | 99.903 |
| 9.52 | 131841. | 5589.3 | 114.769 |
| 9.68 | 151418. | 6419.2 | 131.811 |
| 9.84 | 173855. | 7370.4 | 151.343 |
| 10.00 | 199564. | 8460.3 | 173.723 |

TABLE 5-5a
Ship time: t′ = 35 days

| | Warp | Ship | Ship | Ship | Earth | Earth | Earth | Earth |
|---|---|---|---|---|---|---|---|---|
| | Speed | Accel | c Factor | Distance | Accel | c Factor | Distance | Time |
| Symbols: | ws | a′/g0 | v′/c | s′ | a/g0 | v/c | s | t |
| Units: | | | | light years | | | light years | years |
| | 0.005 | 0.05 | 0.0046 | 0.0002 | 0.046 | 0.005 | 0.000 | 0.096 |
| | 0.01 | 0.09 | 0.0092 | 0.0004 | 0.093 | 0.009 | 0.000 | 0.096 |
| | 0.02 | 0.19 | 0.0186 | 0.0009 | 0.19 | 0.019 | 0.001 | 0.096 |
| | 0.03 | 0.28 | 0.0281 | 0.0013 | 0.28 | 0.028 | 0.001 | 0.096 |
| | 0.04 | 0.38 | 0.0378 | 0.0018 | 0.38 | 0.038 | 0.002 | 0.096 |
| | 0.05 | 0.48 | 0.0476 | 0.0023 | 0.48 | 0.048 | 0.002 | 0.096 |
| | 0.06 | 0.58 | 0.0576 | 0.0028 | 0.58 | 0.057 | 0.003 | 0.096 |
| | 0.07 | 0.68 | 0.0677 | 0.0032 | 0.68 | 0.068 | 0.003 | 0.096 |
| | 0.08 | 0.79 | 0.0779 | 0.0037 | 0.78 | 0.078 | 0.004 | 0.096 |
| | 0.09 | 0.89 | 0.0883 | 0.0042 | 0.88 | 0.088 | 0.004 | 0.096 |
| | 0.10 | 1.00 | 0.0989 | 0.0047 | 0.99 | 0.099 | 0.005 | 0.096 |
| | 0.29 | 3.38 | 0.3343 | 0.0160 | 2.87 | 0.322 | 0.016 | 0.098 |
| | 0.48 | 6.49 | 0.6418 | 0.0307 | 3.63 | 0.566 | 0.032 | 0.103 |
| | 0.68 | 10.5 | 1.038 | 0.0498 | 2.61 | 0.777 | 0.054 | 0.114 |
| | 0.87 | 15.6 | 1.545 | 0.0740 | 1.06 | 0.913 | 0.090 | 0.139 |
| | 1.06 | 22.1 | 2.185 | 0.105 | 0.24 | 0.975 | 0.154 | 0.192 |
| | 1.25 | 30.2 | 2.990 | 0.143 | 0.03 | 0.995 | 0.287 | 0.318 |
| | 1.44 | 40.4 | 3.995 | 0.191 | 0.00 | 0.999 | 0.628 | 0.651 |
| | 1.63 | 53.0 | 5.244 | 0.251 | 0.00 | 1.000 | 1.712 | 1.730 |
| | 1.83 | 68.6 | 6.788 | 0.325 | 0.00 | 1.000 | 6.245 | 6.260 |
| | 2.02 | 87.8 | 8.689 | 0.416 | 0.00 | 1.000 | 32.74 | 32.75 |
| | 2.21 | 111.4 | 11.02 | 0.528 | 0.00 | 1.000 | 266.41 | 266.41 |
| | 2.40 | 140.3 | 13.88 | 0.665 | 0.00 | 1.000 | 3679. | 3679. |
| | 2.59 | 175.5 | 17.36 | 0.832 | 0.00 | 1.000 | 95854. | 95854. |
| | 2.78 | 218.4 | 21.60 | 1.035 | | | | |
| | 2.98 | 270.4 | 26.75 | 1.282 | | | | |
| | 3.17 | 333.5 | 32.99 | 1.581 | | | | |
| | 3.36 | 409.7 | 40.53 | 1.942 | | | | |
| | 3.55 | 501.8 | 49.63 | 2.378 | | | | |
| | 3.74 | 612.7 | 60.61 | 2.904 | | | | |
| | 3.93 | 746.2 | 73.81 | 3.536 | | | | |
| | 4.13 | 906.6 | 89.68 | 4.297 | | | | |
| | 4.32 | 1099. | 108.7 | 5.209 | | | | |
| | 4.51 | 1330. | 131.5 | 6.303 | | | | |
| | 4.70 | 1606. | 158.9 | 7.612 | | | | |

TABLE 5-5b
Ship time: t′ = 35 days

| | | | | | | | | |
|---|---|---|---|---|---|---|---|---|
| | Warp | Ship | Ship | Ship | Earth | Earth | Earth | Earth |
| | Speed | Accel | c Factor | Distance | Accel | c Factor | Distance | Time |
| Symbols: | W | a′/g₀ | v′/c | s′ | a′/g₀ | v/c | s | t |
| Units: | | | | light years | | | light years | years |

| | | | |
|---|---|---|---|
| 4.60 | 1455. | 143.9 | 6.894 |
| 4.76 | 1700. | 168.2 | 8.057 |
| 4.92 | 1984. | 196.3 | 9.405 |
| 5.08 | 2314. | 228.9 | 10.97 |
| 5.24 | 2696. | 266.7 | 12.78 |
| 5.39 | 3138. | 310.4 | 14.87 |
| 5.55 | 3649. | 361.0 | 17.29 |
| 5.71 | 4240. | 419.4 | 20.10 |
| 5.87 | 4923. | 487.0 | 23.33 |
| 6.03 | 5712. | 565.0 | 27.07 |
| 6.19 | 6622. | 655.1 | 31.39 |
| 6.35 | 7673. | 759.0 | 36.36 |
| 6.51 | 8884. | 878.8 | 42.11 |
| 6.66 | 10281. | 1017.0 | 48.73 |
| 6.82 | 11891. | 1176.3 | 56.36 |
| 6.98 | 13745. | 1359.7 | 65.15 |
| 7.14 | 15881. | 1570.9 | 75.27 |
| 7.30 | 18339. | 1814.0 | 86.92 |
| 7.46 | 21167. | 2093.8 | 100.3 |
| 7.62 | 24420. | 2415.6 | 115.7 |
| 7.78 | 28162. | 2785.7 | 133.5 |
| 7.94 | 32462. | 3211.2 | 153.9 |
| 8.09 | 37405. | 3700.1 | 177.3 |
| 8.25 | 43084. | 4261.8 | 204.2 |
| 8.41 | 49606. | 4907.0 | 235.1 |
| 8.57 | 57096. | 5647.8 | 270.6 |
| 8.73 | 65693. | 6498.3 | 311.3 |
| 8.89 | 75560. | 7474.4 | 358.1 |
| 9.05 | 86882. | 8594.3 | 411.8 |
| 9.21 | 99869. | 9879.0 | 473.3 |
| 9.36 | 114763. | 11352. | 543.9 |
| 9.52 | 131841. | 13042. | 624.9 |
| 9.68 | 151418. | 14978. | 717.6 |
| 9.84 | 173855. | 17198. | 824.0 |
| 10.00 | 199564. | 19741. | 945.8 |
| 8.2767 | 44000. | 4352.4 | 208.535 |
| 7 | | | |

TABLE 5-6a
Ship time: t′ = 2 months

| | | | | | | | |
|---|---|---|---|---|---|---|---|
| Warp | Ship | Ship | Ship | Earth | Earth | Earth | Earth |
| Speed | Accel | c Factor | Distance | Accel | c Factor | Distance | Time |

Symbols

| | | | | | | | |
|---|---|---|---|---|---|---|---|
| W | a′/g₀ | v′/c | s′ | a/g₀ | v/c | s | t |

Units:

| | | | light years | | | light years | years |
|---|---|---|---|---|---|---|---|
| 0.005 | 0.05 | 0.0080 | 0.0007 | 0.046 | 0.008 | 0.001 | 0.167 |
| 0.01 | 0.09 | 0.0161 | 0.0013 | 0.093 | 0.016 | 0.001 | 0.167 |
| 0.02 | 0.19 | 0.0324 | 0.0027 | 0.19 | 0.032 | 0.003 | 0.167 |
| 0.03 | 0.28 | 0.0489 | 0.0041 | 0.28 | 0.049 | 0.004 | 0.167 |
| 0.04 | 0.38 | 0.0657 | 0.0055 | 0.38 | 0.066 | 0.005 | 0.167 |
| 0.05 | 0.48 | 0.0828 | 0.0069 | 0.48 | 0.083 | 0.007 | 0.167 |
| 0.06 | 0.58 | 0.100 | 0.0083 | 0.57 | 0.100 | 0.008 | 0.167 |
| 0.07 | 0.68 | 0.118 | 0.010 | 0.67 | 0.117 | 0.010 | 0.167 |
| 0.08 | 0.79 | 0.136 | 0.011 | 0.77 | 0.135 | 0.011 | 0.167 |
| 0.09 | 0.89 | 0.154 | 0.013 | 0.86 | 0.152 | 0.013 | 0.167 |
| 0.10 | 1.00 | 0.172 | 0.014 | 0.96 | 0.170 | 0.014 | 0.167 |
| 0.29 | 3.38 | 0.581 | 0.048 | 2.09 | 0.524 | 0.050 | 0.176 |
| 0.48 | 6.49 | 1.12 | 0.093 | 1.34 | 0.806 | 0.103 | 0.203 |
| 0.68 | 10.5 | 1.81 | 0.151 | 0.34 | 0.947 | 0.196 | 0.273 |
| 0.87 | 15.6 | 2.69 | 0.224 | 0.039 | 0.991 | 0.395 | 0.453 |
| 1.06 | 22.1 | 3.80 | 0.317 | 0.002 | 0.999 | 0.937 | 0.980 |
| 1.25 | 30.2 | 5.20 | 0.433 | 0.000 | 1.000 | 2.874 | 2.906 |
| 1.44 | 40.4 | 6.95 | 0.579 | 0.000 | 1.000 | 12.467 | 12.491 |
| 1.63 | 53.0 | 9.12 | 0.760 | 0.000 | 1.000 | 83.468 | 83.486 |
| 1.83 | 68.6 | 11.81 | 0.984 | 0.000 | 1.000 | 945.828 | 945.842 |
| 2.02 | 87.8 | 15.11 | 1.259 | | | | |
| 2.21 | 111.4 | 19.17 | 1.598 | | | | |
| 2.40 | 140.3 | 24.14 | 2.012 | | | | |
| 2.59 | 175.5 | 30.20 | 2.517 | | | | |
| 2.78 | 218.4 | 37.57 | 3.131 | | | | |
| 2.98 | 270.4 | 46.53 | 3.877 | | | | |
| 3.17 | 333.5 | 57.38 | 4.781 | | | | |
| 3.36 | 409.7 | 70.49 | 5.874 | | | | |
| 3.55 | 501.8 | 86.33 | 7.194 | | | | |
| 3.74 | 612.7 | 105.4 | 8.784 | | | | |
| 3.93 | 746.2 | 128.4 | 10.70 | | | | |
| 4.13 | 906.6 | 156.0 | 13.00 | | | | |
| 4.32 | 1099. | 189.1 | 15.76 | | | | |
| 4.51 | 1330. | 228.8 | 19.07 | | | | |
| 4.70 | 1606. | 276.3 | 23.03 | | | | |

TABLE 5-6b
Ship time: t′ = 2 months

| | | | | | | | |
|---|---|---|---|---|---|---|---|
| Warp | Ship | Ship | Ship | Earth | Earth | Earth | Earth |
| Speed | Accel | c Factor | Distance | Accel | c Factor | Distance | Time |

Symbols

| | | | | | | | |
|---|---|---|---|---|---|---|---|
| ws | a′/g₀ | v′/c | s′ | a/g₀ | v/c | s | t |

Units:

| | | |
|---|---|---|
| light years | light years | years |

| | | | |
|---|---|---|---|
| 4.60 | 1455. | 250.3 | 20.856 |
| 4.76 | 1700. | 292.5 | 24.373 |
| 4.92 | 1984. | 341.4 | 28.452 |
| 5.08 | 2314. | 398.1 | 33.179 |
| 5.24 | 2696. | 463.8 | 38.653 |
| 5.39 | 3138. | 539.9 | 44.989 |
| 5.55 | 3649. | 627.8 | 52.319 |
| 5.71 | 4240. | 729.5 | 60.792 |
| 5.87 | 4923. | 847.0 | 70.583 |
| 6.03 | 5712. | 982.7 | 81.892 |
| 6.19 | 6622. | 1139.3 | 94.946 |
| 6.35 | 7673. | 1320.1 | 110.01 |
| 6.51 | 8884. | 1528.6 | 127.38 |
| 6.66 | 10281. | 1769. | 147.41 |
| 6.82 | 11891. | 2046. | 170.49 |
| 6.98 | 13745. | 2365. | 197.07 |
| 7.14 | 15881. | 2732. | 227.69 |
| 7.30 | 18339. | 3155. | 262.93 |
| 7.46 | 21167. | 3642. | 303.48 |
| 7.62 | 24420. | 4201. | 350.12 |
| 7.78 | 28162. | 4845. | 403.76 |
| 7.94 | 32462. | 5585. | 465.43 |
| 8.09 | 37405. | 6436. | 536.29 |
| 8.25 | 43084. | 7413. | 617.71 |
| 8.41 | 49606. | 8535. | 711.22 |
| 8.57 | 57096. | 9823. | 818.60 |
| 8.73 | 65693. | 11302. | 941.87 |
| 8.89 | 75560. | 13000. | 1083.3 |
| 9.05 | 86882. | 14948. | 1245.7 |
| 9.21 | 99869. | 17182. | 1431.9 |
| 9.36 | 114763. | 19745. | 1645.4 |
| 9.52 | 131841. | 22683. | 1890.3 |
| 9.68 | 151418. | 26051. | 2170.9 |
| 9.84 | 173855. | 29912. | 2492.6 |
| 10.00 | 199564. | 34335. | 2861.2 |

TABLE 5-7a
Ship time: t′ = 20 months

| | | | | | | | |
|---|---|---|---|---|---|---|---|
| Warp | Ship | Ship | Ship | Earth | Earth | Earth | Earth |
| Speed | Accel | c Factor | Distance | Accel | c Factor | Distance | Time |

Symbols

| | | | | | | | |
|---|---|---|---|---|---|---|---|
| W | a′/g₀ | v′/c | s′ | a/g₀ | v/c | s | t |

Units:

| | | | light years | | | light years | years |
|---|---|---|---|---|---|---|---|
| 0.005 | 0.05 | 0.080 | 0.067 | 0.046 | 0.080 | 0.067 | 1.668 |
| 0.01 | 0.09 | 0.161 | 0.134 | 0.090 | 0.159 | 0.134 | 1.674 |
| 0.02 | 0.19 | 0.324 | 0.270 | 0.161 | 0.313 | 0.272 | 1.696 |
| 0.03 | 0.28 | 0.489 | 0.408 | 0.201 | 0.454 | 0.416 | 1.734 |
| 0.04 | 0.38 | 0.657 | 0.548 | 0.208 | 0.577 | 0.568 | 1.789 |
| 0.05 | 0.48 | 0.828 | 0.690 | 0.190 | 0.679 | 0.730 | 1.864 |
| 0.06 | 0.58 | 1.001 | 0.834 | 0.158 | 0.762 | 0.906 | 1.959 |
| 0.07 | 0.68 | 1.177 | 0.981 | 0.122 | 0.826 | 1.099 | 2.079 |
| 0.08 | 0.79 | 1.355 | 1.130 | 0.089 | 0.875 | 1.313 | 2.226 |
| 0.09 | 0.89 | 1.537 | 1.281 | 0.062 | 0.912 | 1.553 | 2.404 |
| 0.10 | 1.00 | 1.720 | 1.434 | 0.042 | 0.938 | 1.824 | 2.620 |
| 0.29 | 3.38 | 5.814 | 4.845 | 0.000 | 1.000 | 47.731 | 48.017 |
| 0.48 | 6.49 | 11.16 | 9.302 | 0.000 | 1.000 | 5.3E+03 | 5.3E+03 |
| 0.68 | 10.50 | 18.06 | 15.05 | 0.000 | 1.000 | 3.2E+06 | 3.2E+06 |
| 0.87 | 15.61 | 26.86 | 22.39 | 0.000 | 1.000 | 1.4E+10 | 1.4E+10 |
| 1.06 | 22.09 | 38.01 | 31.67 | | | | |
| 1.25 | 30.23 | 52.00 | 43.34 | | | | |
| 1.44 | 40.39 | 69.48 | 57.90 | | | | |
| 1.63 | 53.01 | 91.20 | 76.00 | | | | |
| 1.83 | 68.62 | 118.1 | 98.38 | | | | |
| 2.02 | 87.84 | 151.1 | 125.9 | | | | |
| 2.21 | 111.4 | 191.7 | 159.8 | | | | |
| 2.40 | 140.3 | 241.4 | 201.2 | | | | |
| 2.59 | 175.5 | 302.0 | 251.7 | | | | |
| 2.78 | 218.4 | 375.7 | 313.1 | | | | |
| 2.98 | 270.4 | 465.3 | 387.7 | | | | |
| 3.17 | 333.5 | 573.8 | 478.1 | | | | |
| 3.36 | 409.7 | 704.9 | 587.4 | | | | |
| 3.55 | 501.8 | 863.3 | 719.4 | | | | |
| 3.74 | 612.7 | 1054. | 878.4 | | | | |
| 3.93 | 746.2 | 1284. | 1070. | | | | |
| 4.13 | 906.6 | 1560. | 1300. | | | | |
| 4.32 | 1099. | 1891. | 1576. | | | | |
| 4.51 | 1330. | 2288. | 1907. | | | | |
| 4.70 | 1606. | 2763. | 2303. | | | | |

TABLE 5-7b
Ship time: t′ = 2 months

| | | | | | | | |
|---|---|---|---|---|---|---|---|
| Warp | Ship | Ship | Ship | Earth | Earth | Earth | Earth |
| Speed | Accel | c Factor | Distance | Accel | c Factor | Distance | Time |

Symbols

| | | | | | | | |
|---|---|---|---|---|---|---|---|
| ws | a′/g₀ | v′/c | s′ | a/g₀ | v/c | s | t |

Units:

| | | |
|---|---|---|
| light years | light years | years |

| | | | |
|---|---|---|---|
| 4.60 | 1455. | 2503. | 2086. |
| 4.76 | 1700. | 2925. | 2437. |
| 4.92 | 1984. | 3414. | 2845. |
| 5.08 | 2314. | 3981. | 3318. |
| 5.24 | 2696. | 4638. | 3865. |
| 5.39 | 3138. | 5399. | 4499. |
| 5.55 | 3649. | 6278. | 5232. |
| 5.71 | 4240. | 7295. | 6079. |
| 5.87 | 4923. | 8470. | 7058. |
| 6.03 | 5712. | 9827. | 8189. |
| 6.19 | 6622. | 11393. | 9495. |
| 6.35 | 7673. | 13201. | 11001. |
| 6.51 | 8884. | 15286. | 12738. |
| 6.66 | 10281. | 17689. | 14741. |
| 6.82 | 11891. | 20458. | 17049. |
| 6.98 | 13745. | 23649. | 19707. |
| 7.14 | 15881. | 27323. | 22769. |
| 7.30 | 18339. | 31551. | 26293. |
| 7.46 | 21167. | 36417. | 30348. |
| 7.62 | 24420. | 42015. | 35012. |
| 7.78 | 28162. | 48452. | 40376. |
| 7.94 | 32462. | 55851. | 46543. |
| 8.09 | 37405. | 64355. | 53629. |
| 8.25 | 43084. | 74125. | 61771. |
| 8.41 | 49606. | 85347. | 71122 |
| 8.57 | 57096. | 98232. | 81860. |
| 8.73 | 65693. | 113024. | 94187. |
| 8.89 | 75560. | 130001. | 108334. |
| 9.05 | 86882. | 149479. | 124566. |
| 9.21 | 99869. | 171824. | 143186. |
| 9.36 | 114763. | 197449. | 164541. |
| 9.52 | 131841. | 226831. | 189026. |
| 9.68 | 151418. | 260513. | 217094. |
| 9.84 | 173855. | 299115. | 249263. |
| 10.00 | 199564. | 343348. | 286123. |

In the tables 5-1 to 5-7 the equations that are used to compute the dynamic parameters for the ship, as measured in the fixed Earth coordinate system, are only defined for ship speeds that are less than the speed of light, c. In the prime coordinate system in which the ship is at rest all measured speeds relative to the Earth and relative to the destination ahead will also always appear to be less than c if they are somehow measured. The aspect of the dynamics that constitutes a paradox is the observation that the ship is able to continuously accelerate halfway towards its destination at a constant rate and then continuously decelerate the rest of the way towards the destination at a constant rate and, as a result, arrive at the destination point at rest. Then, when the crew on-board the ship record their enroute travel time, they will observe that their travel time and the distances traveled are values that are consistent with the values in the prime coordinate system that are listed in the tables above. These computed prime coordinate system speed values that are listed in the tables are speeds that are in excess of the speed of light, which is a paradox since on the Earth the observed apparent speed of the ship never exceeds the speed of light. Also, notice that the expected travel times on the Earth, t, are predicted to be longer periods than the observed travel times on the ship, t′.

Since when the crew quarters are gravity compensated, and therefore the onboard travel time experienced by the crew is synchronized with Earth time, then the crew can return to the Earth within time periods that are consistent with the predicted time periods t′ in the tables. It is apparent that the time periods t that are predicted for the travel time, as observed on the Earth, appear to be inconsistent with the observed travel times t′. This speed paradox, as observed, from the Earth can be rationalized by claiming that the ship has traveled inter dimensionally to and from a destination point in space.

Warp speeds at and above warp 7 are defined to be hyper warp speeds and are presented in the Tables 5-1 to 5-7. Warp speeds below warp 7 are considered to be warp drive speeds and warp speeds at and above warp 7 are considered to be operations at hyper warp speeds. Warp speeds of up to 8.5 to 8.6 are considered to be physically possible. This contention is based on a report, documented in the March-April 1973 APRO Bulletin, of the observations of a witness who saw a large “tank” like UFO on the ground and photographed the UFO at just the instant at which it took off from the ground about three quarters of a mile from the witness's location near Sedona, Ariz. The witness's photographic evidence recorded the rate of acceleration of the ascending large “tank” like UFO to be on the order of 44000 g₀, i. e. zero to 16,000 miles per hour in one sixtieth of a second which was the time the camera shutter was open. As the witness attempted to photograph the UFO on the ground it took off at a very high rate of acceleration just as the witness snapped the shutter on the camera; and, as a result, the UFO left a streak on the film that recorded its dynamic motion as it ascended while the camera shutter was open. The passage that describes the sighting of the “tank” like UFO is interesting to read and is in a book by Frank B. Salisbury. This book entitled The UFO Display: A Biologist's Report is well researched, informative, and a pleasure to read because of the author's scientific presentation.

An interesting observation is that the copyright date of Frank B. Salisbury's book is 1974 and that this date may be one of the earliest references to the concept of accelerating away from an observer with such a high rate of acceleration that to the observer the accelerating craft appears to jump away from the observer to a pin point of light and then vanish. In Frank B. Salisbury's book The UFO Display this concept is presented in the following passage that describes a luminous craft that was observed on Mar. 23, 1973, at night and at close range over a road: “Then it moved away instantly. It just disappeared. It didn't go out, it just moved away so fast that it pin-pointcd out.”

Reports that UFO craft have been sighted that depart the vicinity where they were being observed at incredibly high rates of acceleration is consistent with the contention that such craft are thrust levitation vehicles. Assuming that such craft were not being built on the Earth prior to say, for example, the mid 1990s and that the large number of reported sightings of such craft confirms the general validity of the reported sightings of the craft, it can be surmised that such craft were and are in some instances extraterrestrial machines that use thrust levitation technologies for propulsion.

Table 5-5 provides some parametric performance data for thrust levitation vehicles with hyper warp speeds of up to warp 8.3 and above, (i. e. 44000 g₀, 208.54 light years in 35 days at warp 8.27677 and at higher warp speeds).

Notice that, as described above and in the following section on relativity, the Correlation theory of relativity explains that the inability of the Special and General theory relativity equations to properly predict the ship trip times and distances for the columns in tables 5-1 to 5-7 with the heading of Earth, i. e. as measured on the Earth, is caused by and is a result of the loss of or the reduction of the correlation of the ship with the Earth. This loss of correlation between the non-inertial reference frame in which the ship is at rest and inertial reference frames, such as the Earth, is due to the continuous acceleration of the ship to speeds, as computed onboard the ship, that are in excess of the speed of light relative to the Earth.

When a ship accelerates to warp speeds and there is a loss of the dynamic correlation of the ship with inertial reference frames and objects within such reference frames then any direct measurements that are made of the dynamics of such objects relative to the ship, and vice versa, are meaningless. Also, the travel times as computed on the ship to destinations are significantly reduced since the correlation between the reference frames is a function of the high acceleration of the ship and the distance between the reference frames.

This dependence of the correlation between the reference frames on distance and the ship warp speed has the effect of reducing the apparent distances that are traveled by the ship. Warp distance and time dilation are analogs of each other since in the first instance the distance that the ship travels appears to be shortened and in the second instance the travel time as measured on the ship appears shorter than the comparable time measured in an inertial reference frame.

Onboard the ship It is possible to compute the dynamics of the ship relative to the Earth and the destination. When the Earth and the ship are no longer adequately correlated because their relative measured speeds are nearly equal to c and when on the accelerating ship the relative speeds are computed as being greater than c, then the dynamics of the ship as measured on the Earth can be said to have lost their significance and to be meaningless. The crew on the ship can compute the relative dynamics of the ship with respect to the Earth and the destination, but will be enable to directly measure these quantities until the relativistic kinetic energy of the ship is reduced to speeds that are significantly less than c.

The paradox, referred to in the paragraph above that is entitled the speed paradox, is that the ship can travel distances such as those listed in tables 5-1 to 5-7 in the time periods t′ that are listed in the tables. Based on the distances that the ship is able to travel and the onboard travel times, t′, that are required in order to travel these distances, the paradox is that the ship can be said to have warped the distances traveled and to have effectively traveled faster than the speed of light.

Additionally, an observer on Earth will contend that because of the affects of time dilation, the travel time as observed from the earth is predicted to be long enough such that, to an observer on the Earth, the ship will appear to have made the trip in a time that is consistent with the distance to the destination divided by an average speed that is always less than c, the speed of light. Such times will be significantly longer than the times measured in the prime coordinate system on-board the ship. The observers on Earth will observe that the ship returns before they expect it to return which is consistent with the contention that the dynamics of the ship as measured on the Earth can be said to have lost their significance and to be meaningless.

For acceleration levels beyond about one to, say, a few g₀ it is necessary to use traction beam systems in order to compensate for the high acceleration levels of the ship and protect the onboard crew from the effects of high acceleration levels. An additional benefit of using acceleration compensation systems, or equivalently gravity compensation, is that the effects of time dilation can be eliminated for the onboard crew. For example, referring to table 5-5b, if a ship accelerates away from the Earth at warp 8.3, i. e. 44,000 g₀, and uses a traction beam system in order to maintain the crew quarters at 1 g₀, then the crew on the ship in about 70 days of onboard travel time can travel to the Pleiades, i. e. the open cluster of stars, Messier M-number M.45, which is about 410 light-years from the Earth.

The technique used in that the ship accelerates halfway at warp 8.3, 44,000 g₀, for 35 days and then decelerates at warp 8.3, 44,000 g₀, for another 35 days at which time the ship arrives at the Pleiades at rest. If the ship drops off some mail and picks up some mail and then turns around and returns to the Earth in another 70 days, then the total round trip travel time that will have passed onboard ship will be 140 days, or 4 months and 18 days. The interesting aspect of the trip is that since the crew was maintained in a constant 1 g₀ environment for the entire 4 months and 18 days, the onboard crew will have experienced the exact same environment as the Earth and the same period of time will have elapsed onboard the ship as will have passed on the earth. The effect is that 140 days on the Earth at 1 g₀ is equivalent to 140 days onboard the ship at 1 g₀. The fact that the ship has traveled to the Pleiades and dropped off some mail and then picked up some mail and returned it to the Earth in a round trip travel period of 140 days means that the average speed of the ship during the cruise was about 810 light years divided by 140/365.25 years or 2113 times the speed of light.

One interesting way to prove these theories or hypotheses would be to build a ship capable of warp 8.3 operations and then ask a space faring “John Glenn” to volunteer to go the Pleiades with a camera, take some pictures, and then return.

The principle of equivalence that is described in books on Special and General relativity states that a system which is stationary in a uniform gravitational field of strength g is physically equivalent to a system which is in a gravitational free space and that is being accelerated with an acceleration g, but that is being accelerated in a direction that is opposite to the sense of the pull of gravity on the first system. Basically, what this is saying is that you can't tell the difference between the pull of gravity and the effects of acceleration if they are equal in magnitude and are being directed oppositely.

The extended principle of equivalence being defined in this disclosure states that if a system is within a traction beam compensated 1 g₀ environment on a craft that is accelerating at warp speeds, i. e. traveling at speeds in excess of say impulse warp 0.1, then this system is physically equivalent to an identical system that is in a uniform gravitational field of strength 1 g₀. One of the important points about this physical equivalence is that the rate of the passage of time in these two systems is identical and is synchronous.

What this means is that, for example, if one of two identical twins stays on Earth and one signs up for a round trip passage on a mail star ship, described in the previous section, that travels to the Pleiades and then back to Earth in about 140 days; then when the twins meet each other again on Earth, they will still be at exactly the same age. In effect, time dilation affects will not cause any differences in their ages because of the effects of the extended principle of equivalence.

Since the speed of light can be exceeded by a star ship, as discussed in the previous few sections by employing traction beam systems and acceleration compensation, it is possible to communicate information onboard a star ship at speeds that are far in excess of the speed of light. It's interesting to note, in comparison to the prior example in the paragraph entitled acceleration compensation, that if the mail had been transmitted by radio or laser systems using communication system rf repeater equipment located along the route that then it would have taken roughly 810 years to communicate a message from the Earth to the Pleiades and receive a response. This period is in comparison to the 140 day round trip travel time of the mail star ship described above. The conclusion is that stellar communications should be delivered by mail star ships instead of by using radio communications such as those that have been and are being searched for with the Search for Extra-Terrestrial Intelligence, SETI, programs.79 p. 96-97 p. 125, 53 Such signals have been referred to as the “wow” signal, signifying that something was out there.

The implications are that any messages that are picked up by the SETI radio searches are likely to be transitory and fleeting intercepted ship communications or other transmissions that are intended to be short range transmissions and that are accidentally and momentarily focused on the Earth by random refraction effects in space.

The question that arises is, is there any evidence or information that can be interpreted to suggest that the most probable types of radio messages that we'll receive from other intelligent beings in space are short messages that are transmitted from underway star ships? Such messages that are transmitted from underway star ships are likely to be highly directive signals or faint radio signals that are momentarily and randomly refracted through the rarefied gas clouds in space such that these signals are received for short periods on the Earth. As a result of the work of the NASA SETI programs that were funded during the 1980s by NASA and by others such as Project META, a number of signals have been received that are candidates signals that appear to meet the requirements and criteria for being messages from intelligent beings in space. META is an acronym for Mega-channel Extra-Terrestrial Assay. The META project is a SETI program that is affiliated with the Planetary Society. This society is an organization that was founded in 1980 by Carl Sagan and Bruce Murray, a planetary scientist.

An example of potential alien signals is the information that, according to Carl Sagan, as of September 1993, suggests about a dozen candidate signal events were observed, after analyzing signals with the META project systems for five years. These candidate signals “ . . . satisfy all but one of our criteria for a genuine alien signal. But the one failed criterion is supremely important: verifiability. We've never been able to find any of them again. We look back at that part of the sky three minutes later, and there's nothing. We look again the following day—nothing. Examine it a year later, or six years later, and still there's nothing.”

Apparently, the answer to the question about whether intermittent signals are received that appear to have been transmitted from alien civilizations, is yes. Therefore this affirmative conclusion can be interpreted to support the contention that alien civilizations are not communicating amongst themselves over interstellar distances with radio systems, but are instead sending their communications, i. e. star ship mail, back and forth on thrust levitation star ships that are traveling at average speeds that are far in excess of the speed of light.

When a ship is traveling at warp speeds then it can traverse distances of light years in mere months of travel time as measured by the crew on-board the ship. Because of the effect of time dilation, the travel time at the departure point and at the destination point, i. e. in fixed inertial reference frames, is a longer time period than the distance traveled divided by the speed of light. This is because the average speed of the ship is always measured to be less than the speed of light in a fixed reference frame. Additionally, the effects of time dilation can be interpreted to be the differences between the travel time values that are observed onboard a star ship, which are or can be significantly less than the observed elapsed time in an inertial reference frame, and the observed elapsed time that passes at both the departure and destination points. At warp speeds, the speed of a thrust levitation ship as observed from a fixed inertial reference frame always appears to be less than the speed of light, but can be very near to the speed of light.

An interesting effect of using traction beam acceleration compensation systems onboard a star ship is that since the crew can be maintained in a constant 1 g₀ non inertial reference frame, the passage of time for the crew members occurs at the same rate as it does within any other 1 g₀ non inertial reference frame. An interesting effect is that if two 1 non inertial reference frames are initially in the same locale and then they travel away from each other on some circumnavigated routes for some period of time and reach some maximum separation distance from each other, that is a significant distance, and then they travel back together such that they are once again in the same locale, then the onboard elapsed times will be observed to be essentially identical. This is true even if the two star ships have been traveling at different warp speeds since during the entire period of time both onboard crews will have both been maintained continuously in identical 1 g₀ non inertial reference frames by their respective onboard traction beam acceleration compensation systems.

The effect that occurs is that an onboard crew expends the energy carried by their ship in order to eliminate the effects of time dilation on the crew quarters. Of course, since star ships travel at warp speeds it is also necessary to use onboard acceleration compensation systems in order to eliminate the crushing affects of the very large ship acceleration levels on the crews and on their quarters. Additionally, notice that the structure of a star ship must be strong enough in order to endure the full affects of warp acceleration levels.

Another concern is that the ship should be designed to accommodate and be built extremely reliably in order for the ship hull regions that are exposed to full warp acceleration levels to operate safely over extremely long periods of time, just in case for some unexpected reason such portions of the ship might have to endure and be exposed to the full effects of time dilation. This last point is subject to interpretation, since it appears that the passage of time on the ship according to time dilation, in an area that is exposed to the full acceleration levels of warp speeds, should be less than the passage of time in a fixed inertial reference frame. Therefore the conclusion is that the hull of the ship won't actually be exposed to extremely long travel times.

A precautionary note is that, although a star ship crew may only experience travel times of months, the outer hull regions of a star ship traveling at high warp speeds might, or could for some unforeseen reason, have to endure hundreds of years of travel or even longer travel periods.

Albert Einstein's Special Theory of Relativity does an excellent job of describing the behavior of light in inertial reference frames and explains the observed behavior of many physical experiments. Special relativity, as formulated by Einstein, was based on two principles that require the laws of nature, as viewed from different frames of reference, to first yield descriptions for space and time that are consistent with the laws of nature and second to then maintain unchanged the content of the laws of nature during a translation from one reference frame to another reference frame. This second principle is called the principle of invariance and has been an important guiding concept during the development of modern physics.

Further, Albert Einstein's General Theory of Relativity is particularly insightful and is a mathematical formulation of relativity that is based on the concept that inertial forces arising from acceleration cannot be differentiated from gravitational forces. Einstein called this concept the principle of equivalence. It is the basis of the General Theory of Relativity.

Neither the Special theory nor the General theory of relativity clarify the unique differences between the behavior of waves such as light and gravity waves and the behavior of particles. In particular, the wave and particle duality nature of matter is not adequately incorporated into Einstein's theories of relativity. Also, the Special theory simply is not applicable to non inertial reference frames and “that is the end of it”; and additionally, there is a break down of Minkowskian space-time for a non inertia observer. Minkowski space is a four-dimensional space-time geometry that is implied by the Lorentz transformations and is a purely geometrical interpretation of the Lorentz transformations. In Minkowski space-time a Lorentz transformation is represented by a rotation. Further, when non inertial reference frames are discussed in books on Special relativity, then typically the results of the analyses in such books are referred back from a non inertial rest frame to an observer in an inertial reference frame by using the concepts of Special relativity and the result is that the affects of non inertial reference frames are obfuscated.

The Special Theory of Relativity proposed by Albert Einstein in 1905 is described and discussed in many books. Special Relativity (SR) is concerned with the laws of physics as observed in inertial reference frames that are moving with respect to each other at constant relative velocities and is concerned with how measurements made within these inertial reference frames are affected by their relative motions. Some of the fundamental principles of SR are that

1. The speed of light is the same in any direction in free space, is the same for all observers, and is independent of the motion of the source of the electromagnetic radiation.

2. All of the laws of physics are the same in every inertial reference frame.

3. Einstein showed that as a direct consequence of the invariance of the speed of light that time and space must be treated as dependent concepts and as a single entity called space-time. Events within inertial reference frames must be described by space-time coordinates and can be transformed between inertial reference frames by the Lorentz transformation.

4. Time dilation is an effect that describes how the clocks within two inertial reference frames that are approaching each other with relative velocities that are close to c will both be observed to be running more slowly than their own.

5. Lorentz contraction is an observed contraction parallel to the motion of an object that is moving at a velocity close to c as observed from an inertial reference frame.

6. The observed mass of an object as measured within an inertial reference frame increases from the rest mass of the object as the relative velocity of the object and the observer in the inertial reference frame increase. Also, the rest mass of an object is an invariant property of matter and only a particle with zero rest mass, i. e. a wave, can be observed to be traveling at the speed of light as observed from and measured within an inertial frame of reference.

Further, Einstein showed that rest mass is a form of energy that can be converted to other forms of energy, that mass and energy can be considered as equivalent, and that they are related by the expression

E=mc²

where E is the total energy of the particle.

The General theory of relativity was presented by Albert Einstein in 1916. It describes how the space-time relationships presented in the Special theory of relativity are affected by the effects of gravity. Since the Lorentz transformation cannot be used to transform the natural laws from an inertial frame of reference to a non inertial frame of reference and because of the principle of equivalence, a facet of General relativity that is reviewed below, the theory of General relativity may alternatively be called the theory of gravitation. Also, Special relativity is not valid in a non inertial frame of reference. Under a coordinate transformation, the laws of nature are form invariant, or equivalently are covariant, which is called the principle of general covariance. By using tensor calculus in order to express the theory of General relativity, the Minkowskian geometry is expressed as a curved space-time geometry that is given by or represented by the line element

ds²=g_{μν}dx^{μ}dx^{ν}

where g_{μν}are functions of the space-time variables which characterize gravitation. The principle of equivalence states that the motion of an object in a uniform gravitational field of strength g is indistinguishable from the motion of the same object in a non inertial reference frame that is being accelerated at a constant rate γ where γ=g.

As a result of the principle of equivalence it is impossible to tell whether a system is in a state of constant accelerated motion since the observed affects are the same as those that would be observed if the system were in a gravitational field. Equivalently, a system which is stationary in a gravitational field of strength g is physically equivalent to a system which is in gravitational-free space, but which is being accelerated with an acceleration of g. This statement of the equality of gravitational fields to accelerated systems is identical to the principle of the equivalence of inertial and gravitational mass. These two concepts are different ways of formulating the same principle which is the basic postulate of General relativity.

Additionally, another key aspect of physics is that a particle that is moving freely preserves its energy and momentum and moves uniformly in a straight line. This statement is an expression of Galileo's Principle of Inertia. According to Einstein's General theory of relativity, for an isolated particle moving freely in four-dimensional space, the particle follows the shortest possible path in space-time as it moves freely between points on a path in space-time that is curved. This second feature of Einstein's General relativity was the starting point for the mathematical formulation of the General theory of relativity.

Other theories of relativity have been developed since 1916 including the Brans-Dicke theory. The main tests of the effects of the relativity theories involve their predictions of the bending of light by gravitational fields, gravitational red shift effects, the effects of curved space-time on the motions of orbiting bodies such as the advance of the perihelion of the planet Mercury, and the predictions of the orbits of binary pulsar star systems.

The fundamental concepts of General relativity are that

1. Electromagnetic radiation or light is bent by a gravitational field.60 p. 94

2. Radio signals are time delayed when transmitted out of a gravitational well, or equivalently when transmitted away from a central gravitational mass.

3. The spectral lines of emitted radiation are red shifted when the radiation travels out of a gravitational well.

4. Clocks run more slowly in a strong gravitational field than they do in a weak gravitational field.

5. The geometry of space-time near a gravitational central mass, or equivalently, in a gravitational well is curved.

6. Gravitational waves are predicted by General relativity.

7. Singularities in the structure of space-time are predicted to be caused by black holes.

8. The gravitational constant G is predicted by General relativity to be a constant.

9. Black holes are predicted to decay by particle emission as a result of the quantum fluctuations of the gravitational field just outside of the event horizon of a black hole.

A particularly interesting presentation on gravity and the General Theory of Relativity is presented in an article in the May 1989 edition of the National Geographic Society Magazine. The author of the article mentioned the possibility of harnessing a force “counteracting gravity” and someday having spaceships “ . . . zipping between planets on ‘hyperdrive’ . . . ”. According to the article, the concept of antigravity was contemplated by Ephraim Fischbach in 1979 and another physicist, Samuel Aronson, during their study of results that they couldn't explain from atomic accelerator experiments. Fischbach and Aronson concluded on Halloween night, 1979, that a fifth force must be involved that would explain the effects they were observing and studying in the particle physics experiments. Their hypothesis was that the exhibited behavior of the particles in the accelerator that seemingly defied gravity was due to a new force—a fifth force.

A new theory of relativity can be envisioned that incorporates both the ability of particles to be accelerated to speeds greater than the speed of light and that is also consistent with the behavior of waves as described by Einstein's Special and General theories of relativity. A non inertial reference frame is an accelerated reference frame, and a non inertial reference frame is one that is accelerated with respect to an inertial reference frame. Let this new proposed theory of relativity be named the Correlation Theory of Relativity, i. e. Correlation Relativity (CR). The theory of Correlation relativity may alternatively be called the theory of acceleration.

The fundamental principles and postulates of CR are

1. All physical laws, including the wave particle duality nature of matter in different frames of reference, converge in form when transformations are made between different frames of reference.

2. The concept that frames of reference are correlated relative to each other or, equivalently, have relative correlation is a fundamental principle of the Correlation Theory of Relativity that incorporates cosmological effects and astronomical observations into the theory of relativity.

Corollary 1—The principle of zero correlation states that it is not possible to directly measure the speed of a particle that has zero correlation, relative to the frame of reference in which the particle is being observed.

Corollary 2—Objects that are traveling at or beyond the speed of light relative to each other have zero relative correlation by definition.

Corollary 3—Objects that have zero relative speeds with respect to each other are 100 percent correlated by definition.

Corollary 4—The relative speeds of objects is a parametric measure that defines the relative correlation level of the objects by definition.

Corollary 5—The zero correlation sphere for any reference point is the spherical surface region centered on the reference point with a radius at which objects have and beyond which objects have, with respect to the reference point, a relative speed that is at the speed of light or is greater than the speed of light.

3. The distances measured in a non inertial reference frame between the non inertial reference frame and inertial reference frames are specified by the time integrals of the acceleration of the non inertial reference frame with respect to the inertial reference frames.

Corollary 1—The particle and wave duality nature of matter does not impose any constraints on the speed of a particle. In a theoretical sense, the relative speeds of matter in the universe may be at speeds approaching infinity.

Corollary 2—An accelerated reference frame can attain speeds that are greater than the speed of light relative to inertial reference frames. These faster than light speeds can be computed, but cannot be measured directly. The effects of faster than light speeds, such as times of arrival, can be observed.

Corollary 3—In inertial reference frames and non inertial reference frames all particle speeds are observed directly to be less than the speed of light.

Corollary 4—The distance between an inertial reference frame and an accelerating reference frame, as measured from the inertial reference frame, is shortened by an integral transformation that is similar to a Lorentz contraction transformation.

Corollary 5—Travel time, as measured in an inertial reference frame, is equal to the Lorentz distance contraction of the distance between the inertial reference frame and an accelerating reference frame divided by the average speed of the accelerating reference frame, as measured in the inertial reference frame.

4. The acceleration of matter produces a field reactive response that is a gravitational wave. A gravitational wave carries an inertial field with a direction that is equal and in the same direction as the inertia of the accelerated matter that produced the gravitational wave. When a gravitational wave is incident on matter, then the inertia carried by the gravitational wave accelerates this matter.

Corollary 2—If the inertia of a gravitational wave is directed in the direction of travel of the gravitational wave, then the inertia of the gravitational wave produces a repulsive force when it is incident on matter. This is a repulsive gravitational wave.

Corollary 2—If the inertia of a gravitational wave is directed opposite to the direction of travel of the gravitational wave, then the inertia of the gravitational wave produces an attractive force when it is incident on matter. This is an attractive gravitational wave.

Corollary 3—A gravitational field produced by a central gravitational mass produces an inertial force field that, when it is incident on matter it, is equivalent in effect to an attractive gravitational wave.

5. The elapsed times measured in non-inertial frames of reference are equal if these non-inertial frames of reference are experiencing the same scalar rate of acceleration.

Corollary 1—The rates of the passage of time in an accelerating environment and in a uniform gravitational field are identical and physically equivalent if the acceleration level and the gravitational field strength levels are physically equivalent.

Corollary 2—The rates of the passage of time is identical in systems that are accelerating at g, in environments maintained at g, and in equivalent uniform gravitational fields with a field strength of g.

Corollary 3—The extended principle of equivalence states that if a system is within the traction beam compensated 1 g₀ environment on a craft that is accelerating at warp speeds, i. e. traveling at speeds in excess of say warp 0.1, then this system is physically equivalent to an identical system that is in a uniform gravitational field of strength 1 g₀. One of the important points about this physical equivalence is that the rate of the passage of time in these two systems is identical.

Corollary 4—According to the extended principle of equivalence, if onboard a ship that is accelerating at a high rate and that is using traction beam and/or repulsion beam systems in order to effectively gravity compensate the occupied areas of the ship for the high acceleration levels of the ship to a 1 g₀ environment; then the passage of time that is measured by the onboard crew will be equal to the passage of time that is measured in other 1 g₀ non-inertial frames of reference even though the ship is accelerating at a much higher rate than 1 g₀.

6. Spacial warp or the concept of gravitational field volume distortion is an effect caused by a gravitational well or equivalently by a traction beam system.

For example, the delays observed in the propagation time of radio signals when they are transmitted out of a gravitational well, or equivalently when they are transmitted away from a central gravitational mass can be interpreted to be due to, and are equivalent to, the increased time of travel of the radio signals that is caused by the increased dimensions of space time that are, in turn, caused by the gravitational well which is produced either by a gravitational mass or by a traction beam system. This increased spacial volume effect is described as spacial warp.

Extended Lorentz contraction is defined in this document such that for an accelerating reference frame, the distance traveled as measured from an inertial reference frame is shortened by a Lorentz contraction transformation. The acceleration of the non inertial reference frame warps the distance traveled by the non inertial reference frame such that when this distance is measured in the inertial reference frame it is shorter.

The paradox that is observed is that if the accelerating reference frame first accelerates to high speed and then decelerates to zero speed with respect to the inertial reference frame, then the total travel time as measured from the inertial reference frame is still equal to the warped distance traveled divided by the average speed of the accelerating reference frame as measured from the inertial reference frame. The non inertial reference frame is observed and is measured from the inertial reference frame to be traveling at a speed that is less than the speed of light. The paradox is that concurrently the non inertial reference frame is observed to be traveling at a speed that is greater than the speed of light as measured in the non inertial reference frame by the onboard crew in their acceleration, and equivalently gravity, compensated environment. The result is that the travel times measured in the non inertial and the inertial reference frames are the same or at least comparable in value.

In summary, as a result of extended Lorentz contraction a paradox occurs that allows an accelerating and decelerating reference frame to effectively exceed the speed of light when traveling inter stellar distances as measured from and in an inertial reference frame even though the speeds measured in the inertial reference frame are less than the speed of light. Notice that the onboard crew would experience the effects of time dilation if their quarters were not maintained at a constant 1 g₀ environmental level by using acceleration compensation.

The concept that frames of reference are correlated relative to each other or, equivalently, have relative correlation is a fundamental principle of the Correlation Theory of Relativity that incorporates cosmological effects and astronomical observations into the theory of relativity. For example, the observation that objects in the universe tend to be traveling at higher relative speeds in space as their separation distances increase and at lower relative speeds as their separation distances decrease is a measure of the relative correlation of the objects. The relative speed of objects in space is a parametric quantity that defines the relative correlation level of the objects.

Objects that are traveling at or beyond the speed of light relative to each other have zero relative correlation by definition. Further, it is not possible to directly measure the speeds of particles that have speeds that are equal to or greater than the speed of light. Equivalently, it is not possible to directly measure the speed of a particle that has zero correlation, relative to the frame of reference in which the particle is being observed, which is called the principle of zero correlation.

According to the definition for the principle of zero correlation, it is not possible to directly measure the speeds of particles that have zero correlation relative to the reference frame from which they are being observed. In contrast to particles, the speed of a light wave which has zero correlation with respect to a reference frame from which it is being observed can be measured in this reference frame. The observation that the speed of a wave traveling at the speed of light can be measured is called the correlation paradox.

Also, although it is possible to directly measure the speed of a wave traveling at the speed of light, the observation that particles can have both a particle and a wave duality nature and that the speed of these particles cannot be measured directly if they are traveling at or beyond the speed of light is entirely consistent with the principle of zero correlation. The speed of a particle can be measured if the particle has a speed that is less than the speed of light, and the particle can be described as having a wave characteristic that defines the position of the particle as a wave packet that is traveling at the speed of the particle. Simultaneously, the waves that describe the position of the particle are traveling at the speed of light.

Restating this last concept in terms of the correlation of a particle, when the relative correlation of a particle is greater than zero, then the wave packet of the particle is traveling at a speed that is less than the speed of light which can be measured while at the same time the waves that characterize the position of the wave packet are traveling at the speed of light. When the particle is traveling at or faster than the speed of light then the relative correlation of the particles zero by definition and, as before, the waves that characterize the position of the particle wave packet are traveling at the speed of light which is another interesting aspect of the correlation paradox.

A question that arises is, when a particle has zero correlation with respect to a reference frame, and the speed of the particle cannot be measured directly from this reference frame, can the particle be observed at all? Or, is the particle by definition in a frame of reference that constitutes or is in a different dimensional space that is invisible? My conclusion is that since the affects of the particle can be observed, that therefore the particle is visible. The particle can become invisible if it pin-points out.

The observations that as the distances to objects in space increase that then their speeds relative to the Earth also increase is entirely consistent with the theory of Correlation relativity. When the separation distances between the Earth and objects in space become arbitrarily large than the relative speeds of such objects relative to the Earth approach the speed of light and the correlation of such objects approaches zero.

Conversely, when the correlation of objects relative to the Earth reaches zero than the speed of such objects relative to the Earth can be equal to and or exceed the speed of light. Also, the concept that objects in the Universe can have zero relative correlation is consistent with the conjecture that the Universe is infinite in extent which is defined in this book as the principle of Cosmological correlation. Therefore, demonstrating that objects in the Universe can have zero correlation is paramount to proving the principle of Cosmological correlation, i. e. that the Universe is infinite in extent.

An interesting observation is that if an object in space is traveling faster than the speed of light and it approaches the Earth, then the measured speed of the object relative to the Earth will always be less than the speed of light. If attempts are made to measure the speed of such an object its speed will be arbitrarily close to the speed of light. Notice that it is possible to infer that the speed of the object is in excess of the speed of light by clocking the time of passage of the object as it travels past check points.

Cosmic rays are examples of objects that can be expected to include some small incident of particle flux density at the top of the atmosphere that exceeds the speed of light. The speeds of such particles traveling in excess of the speed of light could be measured, as mentioned above, by clocking the time of passage of the particles as they travel by a set of two or more clocks.

A postulate of the Correlation Theory of Relativity is that the particle and wave duality nature of matter does not impose any constraints on the speed of a particle. The only constraints imposed, are on the ability of an observer to directly measure the speed of a particle that is traveling faster than light speed as it passes by the observer when he or she attempts to make repeated measurements of the position of the particle from a single location and thereby measure the speed of the particle.

The observation that Cosmic rays are likely to include a high energy flux density with or that corresponds to speeds greater than the speed of light can be explained by observing that in any arbitrary region of space small atomic particles can be expected to be the most abundant objects. Additionally, given that the direction of travel of these abundant atomic particles is entirely random and on average directed uniformly in space, then some small number of these atomic particles that are quantifiable distances from the Earth are likely to be traveling on trajectories that will eventually result in their arrival in the vicinity of the Earth.

It should be possible to predict the distances or minimum distance boundary limits from the Earth at which such fast moving Cosmic ray particles originate and start their journey towards the Earth. Such predictions and estimates for the origin distances of Cosmic ray particles from the Earth can probably be made by using Correlation relativity, estimates for the abundance of atomic particles in space, and by making estimates concerning the flux density of Cosmic ray particles that are traveling faster than the speed of light at the top of the atmosphere of the Earth. In regions of space with high mass density it is likely that the flux density of high energy Cosmic rays will be zero or will be at very low levels as a result of their interactions with other particles and fields.

As stated and implied by the theories of relativity, the only motions that have meaning in the Universe are relative motions. The second postulate of the Special Theory of relativity states that the speed of light is the same in all inertial systems, regardless of the motion of the source. This postulate and the postulates of the Correlation theory of relativity together represent the wave-particle duality nature of matter. Discussions of the Special Theory of relativity and the General Theory of relativity are not reviewed in depth in this document since such discussions are presented in various references and are beyond the scope of this document.

Star Travel

According to the Correlation, i. e. non inertial, theory of relativity, the Galleon transformations1 are incorporated into the non inertial theory of relativity and the distances between inertial reference frames can be measured from or within the non inertial reference frame. For example, a trip from the Earth to the Pleiades star cluster (M45, NGC1432) in Taurus involves traveling a distance of 410 light years. The Pleiades star cluster is a cluster of about 400 stars in a spherical volume with a diameter of about 28 light years. The average distance between the stars in the Pleiades cluster is computed to be 3.1 light years.

The time required to travel to the Pleiades, a distance of 410 light years, as measured onboard a ship that is accelerating continuously at warp 2.42 or 144 g₀ is, according to Table 5-7a, 3.5 years. This travel time and distance are the result of accelerating a star ship at 144 g₀ for 1.625 years and then decelerating the star ship at 144 g₀ for 1.625 years which yields a total travel time as measured onboard the ship of 3.25 years and a total travel distance of 410 light years. Notice that the travel time as measured on the Earth, is also 3.25 years since time dilation doesn't apply to the non inertial reference frame of the ship which is maintained for the crew at 1 g₀ by using a traction beam acceleration compensation system. Also, the ship reaches a maximum speed with respect to the Earth of 247 c, i. e. 247 times the speed of light.

The corresponding travel time, distance, and maximum speed for a trip from the Earth to the star group Zeta Reticuli in the southern sky of the Earth is, using Table 5-6a, 4 months at warp 4.43 or 1230 g₀, 35 light years, and 212 c.

The results listed above were obtained by using the equations that were used in order to produce the values in the tables; approximations for these results can be obtained directly from the tables by interpolation.

Travel at speeds in excess of the speed of light can be interpreted from the inertial reference frame of the Earth as being inter dimensional travel since to an observer on the Earth a star ship simply pin points out and disappears as far as the observer on the Earth can determine. Of course to the crew on the ship, their interpretation is that according to their calculations they are accelerating at such a high rate that they compute that they are traveling at warp speeds and thereby are exceeding the speed of light and are able to travel stellar distances in mere fractions of the time that such travel would take at light speed. When the ship returns to the Earth after having been gone for a relatively short period of time, the observer on the Earth suddenly observes that the ship materializes back into existence in the vicinity of the Earth.

Although the crew of the ship testifies that they have traveled stellar distances and returned in a short period of time by traveling faster than the speed of light; to the observer on the Earth, who notes that objects are never observed to travel faster than light speed, it appears that the star ship was able to travel stellar distances by traveling in another dimensional plane from the one in which the Earth exists, i. e. from the “inertial” reference frame of the Earth. The interpretations of the crew on the star ship and the observer on the Earth about inter dimensional travel both have merit and could be described as being equivalent.

Since, during the stellar trip at warp speeds, the star ship exists in a non inertial frame of reference, the underway star ship does truly exist in a different frame of reference and different type of frame of reference than an inertial reference frame such as the Earth. To the observer on the Earth, when the star ship goes to warp speed and pin points out, the effect is that it is entering into inter dimensional travel and is thereby traveling stellar distances.

A Cosmological Gedanken experiment is a thought experiment that illustrates how objects in the Universe become gradually decorrelated with respect to each other as they become ever more distant from one another. As the separation distances between objects increase then the likelihood that they will be traveling away from each other also increases because of geometric effects. Since their relative velocities are increasing as they become ever more decorrelated then their relative motions will seem to indicate that cosmological objects in the Universe are expanding in extent. In actuality this is not the case, since it makes no difference where as observer is located in the Universe, and where ever an observer is located he or she will always make the same observations if the observations are made on a large enough scale in order to include the effects of a concept named by the author, the zero correlation sphere.

A zero correlation sphere is a very distant spherical region centered on a reference location, beyond which other objects have approximately zero correlation with respect to objects located at the reference location. These objects, in the vicinity of the zero correlation sphere for a reference location at the center of the zero correlation sphere, are very distant from the reference location and are objects that are traveling at speeds relative to an observer at the reference location that are at or greater than the speed of light.

When objects are at or are beyond the distance of the zero correlation sphere that is centered about an observer, then these very distant objects can have non-zero, although typically very small, probabilities of being on a path that is directed towards the observer and at relative speeds that exceed the speed of light. Generally as the relative speeds of objects increase, then the probably that they are on intercept paths decrease and approach zero as their relative speeds approach and exceed the speed of light.

At the Earth, the only objects that an observer would be likely to observe that would be emanating from the distance of the zero correlation sphere of the Earth and therefore approaching the Earth at very high speeds, with possibly even a small particle flux density with speeds at or above the speed of light, would be the most abundant particles in the Universe which are atomic and nuclear particles. At the Earth these high energy particles are known as cosmic rays.

Since particles approaching the vicinity of the Earth from the zero correlation sphere of the Earth gradually tend to become correlated with respect to the Earth during their approach, it isn't likely that many or even any of these cosmic rays will be traveling at speeds that are at or are above the speed of light. The interesting observation is that it can be hypothesized that it is possible for some cosmic rays to be traveling at faster than light speed. Probably the region where faster than light speed particles would be the most likely to be observed, indirectly, would be out beyond the Solar system in interstellar space, where the solar wind from the Sun wouldn't be likely to influence and possibly even slow such particles to below light speeds.

There is a finite and non-zero probability that objects within a zero correlation sphere will be approaching each other or, for example, an object will be approaching another object with an observer onboard. Usually, objects within a zero correlation sphere have non-zero relative correlation and are moving at relative speeds that are less than the speed of light. Notice, that there is no reason why an object cant approach another object with a relative speed at or greater than the speed of light, its just not a very likely situation to occur for typical objects within the Universe. Since star ships are a special case and are unusual objects within the Universe, the speeds of star ships with respect to objects within the Universe could be described as atypical.

Typically objects on the Earth are moving at low relative speeds, objects in orbit about the Earth are moving at higher relative speeds, objects further than orbital distances from the Earth but within a distance that is equal to the radius of the Earth from the Sun at one astronomical unit, or 1 au, are moving at yet higher relative speeds, and objects beyond 1 au but less than the mean radius of Pluto from the Sun at 39.4 au are moving at yet higher relative speeds. As astronomers look ever further out into the universe they observe that the relative speeds of objects with respect to the Earth continue to increase. Also notice that as objects become ever more distant from one another that then they are ever less likely to be on intercept courses simply because of the ever decreasing angular paths that they must follow in order to be on intercept courses with respect to each other.

This process of increasing speed with increasing distance continues until the typical relative speeds of objects with respect to the Earth or with respect to any other reference location in the Universe approaches the speed of light. The distance from the Earth at which objects are typically moving at the speed of light with respect to the Earth is the radius of the zero correlation sphere. Objects at this distance from the Earth are essentially uncorrelated with respect to the Earth. Beyond the radius of the zero correlation sphere, objects are typically moving at speeds relative to the Earth that are beyond the speed of light.

The probability of objects being on intercept paths with an observer is very low when the objects and the observer are separated by distances approaching the radius or boundary of the zero correlation sphere, or by distances beyond the zero correlation sphere. Therefore, the only objects that are likely to be observable in the universe that originate at or beyond the zero correlation sphere and that also have high enough probabilities of being on intercepts paths with an observer that they are observable are very abundant objects such as atomic particles. These high energy atomic particles that are on intercept paths with the Earth and that are traveling at very great velocities are the cosmic rays that scientists have been studying for years. The reason objects can be traveling at very high relative speeds out near and beyond their zero correlation spheres is a result of there being essentially no correlation between such objects and therefore no impeding forces acting, between them that can transfer energy and constrain their relative speeds.

The fact that very distance objects from an observer are very unlikely to be traveling towards an observer is merely a geometric effect that dictates that if objects are approaching an observer, then the relative motion of the objects with respect to the observer must be constrained to be within a very small spherical solid angle, an angular region on the surface of a sphere, surrounding each object if they are on intercepts paths with the observer. All other directions of travel will take the objects away from the observer. This concept is the expanding Universe paradox.

According to the expanding Universe paradox, even though an observer observes that the Universe is expanding, in fact the Universe is not expanding and is instead in a stable and steady state condition.

If the expanding Universe paradox is analyzed within the context of an infinite Universe by using the mathematics of probabilities, integration, and calculus; then this seemingly or apparent paradox becomes one of the features of the concept of an infinite Universe.

As objects approach each other in the Universe they interact and, as a result, become increasingly more correlated as their separation distances decrease. This is true for both particles and field energy such as gravity waves and electromagnetic waves. For particles, the observed effects are that the relative speeds of the particles are reduced and for field energy, such as electromagnetic energy, the frequency of the radiation is gradually lowered. As a result, light energy is gradually field shifted out of the visible region, i. e. frequency shifted, into the lower energy and longer electromagnetic wave length regions. This gradual field shifting of wave energy as a result of increasing correlation effects explains why the night sky is black and is not a bright white even though the Universe has an infinite extent. One of the principle ways in which electromagnetic waves loose energy due to field shifting is as a result of the loss of energy to gravitational fields. Another interesting effect is that, as an electromagnetic signal travels through space, the individual electromagnetic waves that compose the signal gradually start to drift apart along their direction of travel and become more disperse. The entropy of the electromagnetic signal is said to be increasing, i. e. as described in physics text books when systems become less organized. This ever increasing entropy level gradually results in the signal losing it information content, recognizable character, and gradually becoming an ever expanding and weaker electromagnetic wave.

The steady state Universe postulate is a concept that theorizes that neither a universe that consists of an empty void nor a universe that is entirely and uniformly filled with homogenous matter, whatever its composition, is possible. Rather, according to the steady state Universe postulate, the currently observable Universe, timeless and infinite, is the only possible steady state form for the Universe. This postulate is based on the conclusion that the observable Universe is the lowest available stable energy state for the Universe, the lowest stable entropy state for the universe, and a prerequisite structure for a timeless and infinite universe.

As observed from a fixed reference frame, the apparent distance, l₀, that a crew travels on-board a thrust levitation ship that is operating at warp speed, in comparison to the actual fixed reference frame travel distance l, can be interpreted to be decreased by the relativistic term in the following expression:

s′=s{square root over (1−v²/c^{2)}}

The effect is that warp speed is being interpreted to decrease the apparent distance that the ship travels such that the ship doesn't travel faster than the speed of light, but rather the apparent distance that the ship travels is dramatically shortened by inter dimensional travel.

The result is that when a thrust levitation ship travels at high warp speeds then the apparent distance traveled, as measured in a fixed inertial reference frame is warped to shorter distances than the ship actually travels. Another interesting point is that since the thrust levitation ship is actually traveling faster than light speed, after it passes the fixed earth reference frame then the ship appears to simply gradually fade and disappear into the darkness of space even if attempts are made to observe the departing ship with a high powered optical or radio telescope. The effect is that as the ship recedes into the distance any light reflected from or emitted by the ship is gradually red shifted enough until finally this light fades into a low frequency radio signal that has such low power that it cannot be detected.

If an observer in a fixed reference frame were told that a ship that departed a short time ago, had arrived at a distance destination prior to the time at which it should have arrived; then, the observer in the fixed reference frame would explain this early arrival of the ship at the destination by saying it was due to a paradox that shortened the travel distance. The observer in the fixed reference frame would contend that since the observed speed of the ship was less than the speed of light, that the early arrival of the ship at a distance destination point is due to a shortening of the travel distance due to a spacial warp 1 paradox instead of the early arrival being due to the speed of the ship having somehow been faster than the speed of light.

The observer on a fixed inertial frame of reference can interpret the shortening of the distance traveled as a warping of the dimensions of space and can interpret the cause of this warping as being due to and as a result of the ship traveling at warp speed. On the ship, the crew will interpret their early arrival at their destination as having been due to their continuous and rapid acceleration and deceleration which resulted in the ship having attained an average speed that was far greater than the speed of light. This type of travel can be described as or argued to be inter dimensional travel.

As a hypothetical example; if a thrust levitation ship, as observed from the Earth and according to the data in Table 5-6a, were able to accelerate at warp 4.7 for 2 months of onboard time and then decelerate at warp 4.7 for 2 months of onboard time, then the ship will have traversed a distance of 46 light years in 4 months of onboard travel time. The onboard crew in a gravity compensated crew area, will have aged 4 months.

The observer on Earth which is the departure point for the craft will predict that the period of time that should have passed, because of the affects of time dilation, is about 47 years since as was observed from the Earth, the ship appeared to obtain light speed a short time after having departed and according to the observer on Earth couldn't have gone any faster.

If in addition the departure point and destination point are traveling at high relative speeds in comparison to the speed of light, then additional time dilation effects will also be predicted to occur and to produce variations in the observed passage of time between the departure point and the destination point that are some fraction of the total expected ship travel time. The observer on the Earth wont actually be able to observe the arrival of the ship at its destination point 46 light years away after 47 years, but if the ship were to turn around and return to the earth in another predicted 47 years, then the observer would expect to see the ship arrive back after a total period of 94 years. Mean while, onboard the ship, the crew members will have measured that their round trip travel time was 8 months.

The interesting and surprising observation that the observer on the Earth will make is that although the expected total trip time was suppose to be 94 years, that instead the observer will discover the ship has arrived back after a mere 8 months, which is the same time that was experienced by the onboard crew. The observer on the Earth will then observe that the crew couldn't have made the trip at warp 4.7 unless their crew quarters were gravity compensated to 1. Next the observer will conclude that as a result, somehow the passage of time on the ship was synchronized with Earth time. The observer will also conclude that, since according to the observer's measurements, the ship didn't exceed light speed; but, that instead the ship must have traveled inter dimensionally and that the actual inter dimensional distance traveled in 8 months at nearly light speed was about 8/12of a light year.

The conclusion is that as a result of the continuous high acceleration level and the subsequent continuous high deceleration level used by the thrust levitation ship; that the ship appears, to an observer in a fixed inertial reference frame, to have warped space and thereby traversed a distance of 46 light years in a four month period and will therefore have on average effectively exceeded the speed of light by a factor of 138.

The phenomena of spacial warp is predicted to produce a three-dimensional volume increase for the inside region of a structure and is produced by applying a traction beam inside of an enclosed volume. Spacial warp can make more usable space available inside of a craft than appears to be available based on the outside dimensions and the mass of the craft. The effect is that traction beam energy can be expended in order to increase the usable and available space inside of a small craft.

It is postulated by the author, based partially on the information in the following section, on the concept of gravitational field volume distortion, that traction and repulsion beams can distort the normal three dimensional space inside of a metallic structure. The concept is that when, for example, a radial traction beam field is activated within an enclosed space, such as a metallic cylindrical volume with an inner radius r and an inner height h, that then the measured value of the radius r inside of the cylinder will be observed to have clearly and significantly increased.

For example, an observer inside of a cylindrical volume will observe that when a traction beam with a radially directed field is activated inside of the cylinder that then the usable space in the cylinder will increase significantly. This is the case if the traction beam field that is radially directed outward from the axis of the cylinder has an intensity that produces on the order of a 1 centrally directed inertial attractive force at the perimeter edge of the cylinder and along the inner wall of the cylindrical volume. Also, when the traction beam is engaged, an observer inside of the cylinder will observe that the diameter of the cylinder and available space inside of the cylinder has been increased significantly by spacial warp. Concurrently, an observer on the outside of the cylinder will not observe any differences in the apparent dimensions of the cylinder and will still measure that the cylinder has the same dimensions that it had before the traction beam field was activated.

It is interesting to note that a centrally directed traction beam is essentially equivalent to a gravitational cylindrical potential well that is centered on the axis of a cylinder. This equivalent gravitational potential well could be defined mathematically as and in terms of an equivalent gravitational mass that is located along the central axis of the cylinder.

The magnitude of the spacial warp 1 effect can be quantified and predicted for the observed increase in the volume of a cylinder, as represented by the measured increase in the radius of the cylinder, i. e. the observed increase in the value of r. In order to predict and quantify the increase in the value of r, use the fundamental concepts of General relativity and the associated equations that predict the delay period that radio signals experience when they are transmitted out of a gravitational well or, equivalently, when they are transmitted away from a central gravitational mass. Then assume that this delay is caused by an increase in the radial path distance, r, that the radio signals must travel when they are transmitted out of the effective gravitational field which can be due to a gravitational mass located, for example, along the axis of a cylinder or due to an equivalent traction beam that is producing a radial gravitational field in cylindrical coordinates.

The associated fundamental concept of General relativity is the statement that, radio signals are time delayed when transmitted out of a gravitational well, or equivalently when transmitted away from a central gravitational mass.

The interior dimensions of a space ship that are available for use by the onboard crew may possibly be increased beyond the exterior volume that is seemly displaced by the ship. I speculate that it is possible to predict mathematically that the interior dimensions of a ship can be increased beyond the volume displaced by the ship by up to a factor of 10 times the size of the normal volume of the ship. This speculation and premise is based on the first hand report of observations that were made by an Air Force photographer, who was a witness, and who said that he and other AF personnel boarded a saucer shaped craft that was inspected during 1973 near Norton AF base in California. According to the witness, he inspected and photographed for the AF a disk-shaped craft with an exterior that appeared to be about 30 feet in diameter and about 10 times larger than this on the inside. He said, “I could have thrown a football as hard as I could and not hit the other side.”

The technique postulated for use in order to implement spacial warp could possibly be used in order to stretch or extend the interior dimensions of a space ship and thereby significantly increase the interior volume of a ship. The proposed approach involves employing a gravitational field space-time distortion generation system. The physics employed involve the supposition that it is possible to distort space-time within the small confines of the enclosed volume of a space ship by using a thrust levitation force field. The contention is that when a thrust levitation attractive force is employed within a confined volume that then the interior size of this volume actually increases and this increased interior volume is available for use by any objects or living creatures that reside inside of the volume.

In order to implement a gravitational field space-time distortion generation system, the interior floor of the ship would be designed in normal space such that it would be a convex floor that would extend to the circular perimeter walls of the ship. Then a high performance cylindrical traction beam system would be placed just below the convex floor in the center of the ship and the traction beam system would be directed upward through the floor of the ship towards the outer circular perimeter walls of the ship.

By operating the gravitational field space-time distortion generation system at an appropriately high power level, the perimeter wall region of the interior of the ship should be significantly increased in size and in radius as measured inside and from the center of the ship. The result is that once the interior perimeter dimensions and volume of the ship have been increased in size by the gravitational field space-time (volume) distortion generation system, then the interior outfitting of the ship could be completed. The increased dimensions of the field distorted interior volume of the ship would be maintained by designing the gravitational field volume distortion generation system to be turned on and powered up permanently by using fail safe implementations. Until adequate experience is obtained, it would be appropriate to implement system designs that would allow the volume distortion generation system to be powered on and off.

The power level of the gravitational field distortion generation system could be applied such that the resulting cylindrical radiating traction beam effect would allow a person to walk towards the outer perimeter edge of the inside wall of the ship. As a person walks across the convex floor, the floor on which the person was standing would always seem to be in the vertical downward gravitational field direction. In empty space, far from any central accelerating gravitational field mass and while the ship was sitting still in space, or equivalently coasting along, a 1 gravitational field would be maintained towards the convex floor inside of the ship by the onboard gravitational field distortion generation system.

Additionally, when a ship is underway, then a constant 1 gravitational field could be maintained onboard the entire floor region of the ship by superimposing a gravity field compensation system within the ship interior areas.

The advantage of using a spacial warp system onboard a star ship is that it would allow a smaller ship exterior size, structure, and mass to be used for the ship, for any given crew size, and thereby allow a star ship to achieve higher warp speeds at lower overall power consumption levels.35 Also, for a description about how to quantify the effects of a gravitational field distortion generation system, refer to the paragraph above entitled Quantifying Spacial Warp.

A thrust levitation automobile vehicle class could be developed that would be able to operate just a few feet above a standard road. By properly extending the thrust levitation technology presented in this book, a thrust levitation automobile could be designed that would be able to operate safely just above existing roads. Such a thrust levitation automobile would have positive control even in high cross wind conditions and would be able to operate in amongst heavy rush hour traffic on all city streets, interstate highways, and up and down the steepest mountainous roads and highways.

It is estimated that thrust levitation automobiles would be able to operate economically and be able to achieve mile per gallon fuel economies that are comparable to or possibly even better than modern US and foreign mid sized cars. The premise for such cost effective performance estimates is that thrust levitation automobiles wouldn't have to use energy absorbing drive trains and wheels and tires that are in contact with rough roads. The power trade off required would be that instead, levitation automobiles would have to use engine power in order to maintain their hovering clearance above the road bed. Levitation automobiles could be designed to operate automatically a few feet off of the ground and automatically prevent vehicle sideways slipping using control mechanisms akin to modern ABS braking systems (automatic Anti-lock Braking Systems), would use very little power in order to maintain their forward motion, and would be exceedingly quiet since there wouldn't be any road noise from wheels and tires.

### Theoretical Applicability

The inventors claim the following concepts are embodied in or form a part of their invention

1. A new gravitational force field based technology named thrust levitation comprising:
thrust levitation propulsion;
beam forces for traction and repulsion beams;
inertial beam wave (i. e. gravity field) technologies including communication applications;
spacial warp to increase the available interior volume of enclosed structures;
vehicle applications such as the automobile, single stage to orbit space ships, other space vehicle applications; and
the basis for a new understanding of physics that allows mass inertia reaction effects to efficiently produce thrust propulsion forces and produce reaction torque from standard motor and engine driven torque.

2. A thrust levitation mechanism comprising:
a mechanical design for transforming angular inertia into linear inertia for propulsion;
the definitive mathematical physics descriptions for balancing powered driven torque with reaction torque;
the concepts necessary to use vehicle symmetry and/or momentum balancing wheels in order to control vehicle angular momentum; and
conceptual descriptions that are presented for the engineering designs and the concepts of thrust levitation technology by using mathematical physics.

3. A thrust levitation reaction force propulsion engineering technology comprising:
drive torque to reaction torque transformations;
drive torque to reaction force transformations; and
that provide vehicle lift, horizontal propulsion, the control forces that are needed in order to maneuver and maintain vehicle control in the atmosphere and equally well in space.

4. An inertial levitation and thrust technology comprising:
a propulsion system that converts vehicle onboard power into rotational inertia and then subsequently into linear inertia by using driven torque to reaction torque and reaction force transformations; and
produces vehicle propulsion without using rockets, the movement of mass by the use of propellers or screws, the rotation of wheels in contact with a ground surface or surfaces, magnetic levitation or magnetic inductive propulsion based on magnetic fields coupling to ground structures.

5. A method of producing and projecting traction and repulsion force beam systems comprising:
thrust levitation mechanisms that when they are powered up and then held in place such that they cannot move in response to the powering mechanisms that then these mechanism produce force beam and inertial beam wave (i. e. gravity field) effects.

6. A method of producing dimensional volume change effects for enclosed structures that are described as spacial warp 1 effects comprising:
the affects of an inertial field force beam system that is engaged within and/or adjacent to an enclosed volume.

7. A method and the mechanism design techniques for producing vertical and horizontal thrust comprising:
the steps of controlling and dynamically varying the orientation of lifting disk rotor configurations as the main rotor or rotors rotate in the horizontal plane.

8. A method for producing free wheeling lifting bob rotors and free wheeling main rotors comprising:
bob rotors (a rotor hub with short rotor arms that each support a bob rotor mass) configured such that the bob rotors are free wheeling and are automatically and efficiently powered by reactive torque on the end of;
prop rotor arms when power is supplied in order to drive the rotation of;
powered prop rotors with arms which each support a bob rotor and which all acting together provide reaction torque to the drive a free wheeling;
main rotor.

9. A bob rotor mechanism and the methods of design of such systems comprising:
a rotor hub and rotor arms that each support a bob rotor mass; and
obvious extensions of and simple geometric configuration variations of the concepts that are presented in this invention disclosure.

10. A vertical reaction force control capability for a thrust levitation vehicle comprising:
using the orientation angle of a lifting disk rotor about the axis of a main rotor arm that is referred to as the pitch angle of a disk rotor (or a bob rotor) and that provides nearly instantaneous control or modulation of the vertical reaction force that is produced by the lifting disk rotor or bob rotor as it is swept around the vertical axis of the main rotor by a main rotor arm.

11. A horizontal reaction force control capability for a thrust levitation vehicle comprising: using an angle referred to as the skew angle which is the orientation angle of a lifting disk rotor (or a bob rotor) about a vertical axis through or near (i. e, next to) the vertical center of the disk rotor (that is referred to as the skew angle of the disk rotor).

12. A horizontal reaction propulsion mechanism, able to propel a vehicle in some desired heading direction, comprising:
lifting disk rotors (or bob rotors) that are controlled by the dynamic (or equivalently by the parametric) variation of the disk rotor skew angles as the associated main rotor arms are rotated about the axis of the main rotor such that the disk rotors are cyclically and synchronously moved back and forth about vertical axes through the center of the disk rotors.

13. A horizontal reaction propulsion mechanism able to apply a horizontal propelling force to a vehicle comprising:
disk rotors that control the disk rotor skew angle with a rate factor referred to as sway such that a horizontal reaction force is swept around the perimeter edge of the vehicle in either a clockwise or a counter clockwise direction.

14. An inertial field force beam transmission and/or transmitter-receiver system comprising:
a thrust levitation system that is held in place and driven with power applied to the main rotor and the disk rotors which produces;
a traction force beam above the thrust levitation system; and
a repulsion force beam below the thrust levitation system.

15. Mechanisms for impulse force beams, sensory systems that remotely measure the mass of objects, pumps that propel liquid with force beams, electronic communication implementations that can both transmit and receive, and et cetera are obvious thrust levitation system extensions comprising:
an inertial field force beam transmission system.

16. A traction force beam system towards the left comprising:
an inertial field force beam transmission system which is located to the right that if allowed to move would move to the left.

17. A repulsion force beam system towards the right comprising:
an inertial field force beam transmission system which is located to the left that if allowed to move would move to the left.

18. Mechanisms can be produced to control inertial field force beams comprising:
attributes such as focal point, beam width, field intensity, and et cetera by varying the geometry of the inertial field beam system rotor mechanisms.

19. Attractive, i. e. traction beam fields and forces comprising:
inertial field force beam systems that are similar to or equivalent to gravitational fields and forces.

20. Repulsive beam fields and forces comprising:
inertial field force beam systems that are similar to, but opposite in effect or sign to those of traction beam fields and forces;
inertial field force beams that do not occur naturally in nature, i. e. traction beam fields and forces are similar to gravitational fields and forces.

21. A spacial warp system comprising:
a traction beam system inside of an enclosed volume making more usable space available inside of, for example a craft, than appears to be available based on the outside dimensions of the craft.

22. Mechanical design analyses and the fundamental thrust levitation concepts comprising:
driven torque, reaction torque, reaction forces, and associated momentum balancing systems that describe how to convert vehicle onboard energy directly into linear inertia which can produce vehicle thrust without, for example, using rocket propulsion, jet engine thrust, propellers, wheels in contact with rails or a road, magnetic levitation, or other currently available and/or conventional propulsion systems.

23. A mechanical vehicle propulsion system that can operate equally well within the atmosphere or in space comprising:
mechanisms which convert vehicle energy directly into vehicle accelerating force by using the new physical concepts and engineering principles described as thrust levitation technology in this invention disclosure.

24. The essence of a new break-though technology collectively described as thrust levitation comprising:
the mechanisms, concepts, analyses, and system designs that produce thrust, beam forces, inertia field transmission beams, spacial warp, and the system applications;
which are implemented by a “torque to force transformation” that converts engine driven torque into a reaction force that lifts and/or thrusts vehicle propulsive systems, for example, in an upward direction.

25. A thrust levitation key attribute is the use of standard engine torque comprising:
technology that converts onboard engine power into standard engine torque which is then converted into vehicle thrusting force without employing conventional systems such as propellers, screws, jet thrust, rocket thrust, magnetic levitation, driving wheels, or et cetera;
although the engines used to power thrust levitation systems could be of any type capable of producing output drive torque with adequate power in order to provide the power required by the thrust levitation mechanisms and systems.

26. Another important aspect of thrust levitation systems is their energy efficiency comprising:
the ability of a thrust levitation mechanism to operate with very high energy efficiency levels of, for example, 90 percent efficiency in terms of the utilization of the available output engine power; and
based on efficiency levels that are dependent on the parametric design parameters that are developed and selected during the design of a particular thrust levitation system implementation.

27. A thrust levitation mechanism design configuration comprising:
an upper main rotor with lifting disk rotors that is a mirror image of a lower main rotor with lifting disk rotors;
where the upper and lower main rotors are counter rotating in order to balance the total system angular momentum such that it sums to a value of zero and thereby allows the total system to operate and maneuver without being constrained by the effects of a non-zero system angular momentum vector.

28. Another key feature of thrust levitation systems is the angular momentum balancing capabilities comprising:
mechanical design configurations employing both upper and lower main rotor configurations such that the total system angular momentum vector sums to zero; or
mechanical design configurations employing a single main rotor and momentum balancing wheels whose momentum when summed together yields a total system momentum vector that has a zero value; and
single main rotor configurations and free wheeling bob and free wheeling main rotor configurations, as claimed in claim 8, whose momentum when summed together yields a total system momentum vector that has a zero value.

29. A thrust levitation main rotor comprising:
a seven sided star wheel heptagon main rotor configuration and other similar configurations such as three, five, and higher number star wheel systems which can be implemented with either prop and bob rotors or simple lifting disk rotors;
a single or dual main rotor configuration with a main rotor design consisting of a seven sided star wheel heptagon constructed with seven identical length sections across the star wheel such that they are all positioned or extend across the main rotor just next to the main rotor axis, but not crossing the main rotor axis.

30. A thrust levitation mechanism able to provide the angular momentum required to control and maintain the vehicle total angular momentum vector at a value of zero comprising:
a single main rotor;
prop rotors; and
bob rotors;
configured by using pitch angles for the bob rotors that can be powered by either driven torque or reaction torque such that the bob rotors provide the required angular momentum to balance the total angular momentum of the vehicle to a value of zero, similar to the claims in claim 28.

31. A fundamental new understanding of physics comprising:
explanations of how to convert energy to thrust levitation drive and the associated analyses and system design techniques that are based on torque to force vector mathematical physics analysis derivations that obviate future extensions.

32. Gravitational potential dynamics and prediction analyses comprising:
mathematical physics expressions that characterize, analyze, design, and evaluate the performance and efficiency of thrust levitation propulsion vehicles.

33. Thrust levitation parametric design techniques, methods, and approaches comprising:
the analyses, definitions, illustrations, and examples that are presented in this invention disclosure.

34. A thrust levitation mechanism that is driven by a single drive shaft comprising:
a variety of gear configurations that can be extended for use in new applications and are typified by the gears and rotors illustrated in FIG. 34 where the rotor shafts annotated by the asterisks are fixed to the frame of the vehicle and are a key attribute that allows a single drive shaft to power a thrust levitation mechanism.

35. An approach of extending thrust levitation design approaches to new vehicle designs comprising:
using the same mathematical design techniques and approaches that are presented in this invention disclosure and applying them on high performance computers for new vehicle system geometry.

36. A specific example of a system analysis and design approach comprising:
a derivation for a thrust levitation system as is illustrated in sections 3.1 and 3.2;
assigning values to vehicle design parameters as is illustrated in section 3.3; and
then numerically evaluating the performance of a vehicle design as is illustrated in section 3.4 by computing a propulsion performance efficiency value.

37. A mechanical design concept comprising:
the ability to perform vehicle performance parametric design studies and predict the performance efficiency of proposed thrust levitation vehicle system designs, as illustrated in sections 3.2 and 3.3.

38. One, two, and three dimensional thrust levitation system analyses comprising:
for example, the one and two dimensional thrust levitation vehicle designs that are characterized, described, and presented in this invention disclosure.

39. A thrust levitation power efficiency analysis comprising:
the mechanical design analysis techniques that are illustrated in section 3.4; and that can be extended and implemented for more sophisticated thrust levitation vehicle designs.

40. Advanced thrust levitation and vehicle concepts comprising:
extended versions of the mechanical design concepts and applications that are presented in this invention disclosure; and
a complete scope of vehicle applications extending from the automobile class characterized in section 3.5 to advanced space ship class vehicles, section 5.5.5, whose design and operational requirements must take into account the new cosmological concepts that are presented in this invention disclosure, as described in sections 5.2.3 and 5.3.

41. Thrust levitation vehicle classes comprising:
light weight and heavy weight vehicles as is illustrated and presented in this invention disclosure;
and as claimed in claim 40.

42. A thrust levitation automobile vehicle class comprising:
a vehicle that is able to operate on roads just a few feet above existing roads;
a class of vehicles that is characterized by the application descriptions.

43. A thrust levitation transport vehicle comprising:
a vehicle design optimized for operations both in the atmosphere and in space;
the craft is trapezoidal in shape as viewed from the side, with symmetric front and aft vehicle ends that slope down towards and to the bottom of the vehicle at about a 30 degree angle, and a vehicle that is approximately rectangular in shape when viewed from above with slightly rounded corners, and with the front and the aft ends of the vehicle being completely symmetric;
the craft is about 130 feet long and 27 feet wide with a gross weight of, for example, 64000 pounds, and is powered by engines yielding at least 4000 horse power; and
is illustrated and described by the invention disclosure material.

44. An aerospace superiority vehicle comprising:
thrust levitation and inertial field force beam system capabilities in a single vehicle design yielding vehicles that ter able to accelerate at very high rates while compensating the effective acceleration levels on board the vehicle in the crew habitation areas i. e. crew quarters and in areas housing sensitive equipment, by employing traction and repulsion force beams in order to cancel out the high thrust levitation propulsion acceleration levels and thereby maintain the crew habitation areaqs at 1 g₀ environmental levels.

45. A self contained and reusable launch single stage to orbit (SSTO) vehicle and space transit vehicle comprising:
a vehicle propelled by thrust levitation; and
a thrust levitation space transit vehicle that is highly efficient.

46. A single stage to orbit (SSTO) vehicle comprising:
a thrust levitation space launcher craft with a mass fraction capability of about 3% using turbine fuel and both atmospheric and onboard oxygen;
a thrust levitation vehicle able to reach an orbital altitude of 500 miles in a time period of about 1 hour; and
designs as claimed in claim 43.

47. Electronic thrust levitation systems comprising:
implementations that convert electrical power directly into vehicle thrust by using, for example, a mechanical main rotor and lifting disk rotor equivalents consisting of crystal or ceramic structures on the arms of the main rotor that vibrate with vibration modes that move the mass of the vibrating structure of the crystal or ceramic in motions analogous to the circular motion of lifting disk rotors;
or particle accelerators, or super conductivity, or electric motors, or et cetera that perform equivalent functions; and
electronic implementations that are capable of both transmitting and receiving gravity waye signals;
and the capabilities claimed in claim 15.

48. An electronic particle thrust levitation system comprising:
driven plasma streams within a plasma containment field system that moves the plasma mass in circular motions similar to the motion of the mass in a lifting disk rotor as it moves about the axis of a thrust levitation system main rotor; also, conceivably, the containment field for the plasma could be designed such that the plasma would also generate power for use onboard the vehicle by using nuclear fusion.

49. A thrust levitation system comprising:
lifting mass, that performs the same function as the mass in a lifting disk rotor, that is driven by using pumped liquids, or gases, or electrically driven crystal or ceramic structures vibrating in rotational modes such as those claimed in claim 47; and mechanically driven main rotor systems.

50. A thrust levitation ship capable of making round trip voyages within the Solar system comprising:
thrust levitation vehicles that are nuclear powered; and are similar to the claims in claims 43, 44, 45, and 46.

51. Warp speed acceleration levels that are attained by thrust levitation space ships comprising:
the use of nuclear power systems for long duration space operations;
the warp equation which specifies the acceleration level at which a space ship is operating;
a warp number W that can range from a value of 0 to 10, although in practice the maximum value of the warp number W is expected to be less than 10, i. e. since a value of 10 is not considered to be, or equivalently does not correspond to, a physically attainable acceleration level because under such high warp number conditions, a space ship would most likely be exposed to structural loads that are beyond any conceivable ship design capabilities.

52. A thrust levitation space carrier vehicle nuclear, TLS/CVN, comprising:
very large space ships which have dimensions that could be typified by a length of 1000 meters and a gross weight of for example, 100,000 tons fully loaded; 10 million shaft horsepower (shp) divided up amongst 360 output power shafts which each provide about 28,000 shp or less to 360 thrust levitation shaft powered propulsion systems;
by operating at 90 percent efficiency is able to attain warp 1 Acceleration levels which correspond to acceleration at 22 times the acceleration of earth gravity as measured at the surface of the earth, i. e. 22 g₀; which uses traction and repulsion force beam systems in order to maintain the crew quarter areas of the ship at comfortable 1 g₀ environmental levels; and which is described in the disclosure above.

53. A new theory of relativity and cosmological analyses that define the design requirements for a thrust levitation space ship comprising:
the scope of thrust levitation vehicle classes and applications as claimed in claim 40;
a new understanding of cosmology, cosmological assertions and discussions, and mathematical relativity analyses and presentations; and a new theory of relativity claimed, presented, described, and named in this invention disclosure The Correlation Theory of Relativity, i. e. Correlation Relativity (CR).

54. A new theory of relativity named The Correlation Theory of Relativity comprising:
support for the concepts of inertial field force beams, spacial warp, how matter produces a field reaction response that is a gravitational wave; that a gravitational wave carries an inertial field that has the same direction, i. e. sense, as the inertia of the accelerated matter that produced the gravitational wave; and that when a gravitational wave is incident on matter, that then the inertia carried by the gravitational wave accelerates the matter in the direction of the inertial field carried by the gravitational wave.

55. An extended principle of equivalence comprising:
the information needed in order to understand the design requirements for thrust levitation space ships that are intended to travel great distances for which travel at low acceleration levels is not practical; understand the passage of time for the crew on a space ship that is accelerating at a high acceleration levels that are too high for the crew to endure and who are protected form the high acceleration levels of the underway space ship by using traction and repulsion force beams in order to gravity compensate the crew quarters to comfortable 1 g₀ (while the space ship is underway at very high acceleration rates); understand that since the crew resides within gravity compensated living quarters that are maintained at comfortable 1 g₀ levels, that then the passage of time for the crew is synchronize with and is identical with the passage of time in all other frames of reference that are also in uniform 1 g₀ gravitational fields such as the surface of the earth.

56. A concept named a zero correlation sphere comprising:
the concept within Correlation Relativity that the relative spacial correlation of objects is a measure of their relative speeds; that if objects are separated by enough distance such that their relative correlation is zero, that then their relative speeds can exceed the speed of light; the radius about an object in the Universe at which a preponderance of other objects are traveling at or faster than the speed of light is the distance, or region, of the surface of the zero correlation sphere associated with the location of the object; and
all locations can be said to be associated with, or have, a zero correlation sphere.

57. Faster than light speed operational concepts comprising:
the design system requirements needed in order to allow a thrust levitation space ship to undertake high performance space missions which are referred to in this invention disclosure as inter dimensional space travel; and as claimed in claims 40, 41, and 53.

58. The apparent or observe speed of a space ship as being less than the speed of light as measures directly, for example, from the earth comprising;
the observation that an object always appears to an observer to be moving at less than the speed of light;
this last observation is not a contradiction of the concept that t thrust levitation space ship that is employing onboard traction and repulsion force beam gravity compensated 1 g₀ environments can travel at speeds in excess of the speed of light.

59. A pin-point out effect comprising:
as observed from Earth that a high performance space ship would appear to go from a visible object, to a visible pin point of light, and then to just totally disappear, this effect has been described as involving a ship or craft that appeared to a casual observer to have “pin-pointed out”; and
the observation that a space ship, as claimed in claim 58, will always appear to be traveling at less than the speed of light, but that if the space ship is using thrust levitation in order to actually travel at speeds in excess of the speed of light, that then the space ship will be observed from the Earth to pin-point out; and having an object suddenly just totally disappear in an instant which is the effect an observer would see if a space ship were being observed when it suddenly went to, or jumped to, high warp speed as is claimed in claim 51.

60. Inter dimensional space travel comprising:
warp speed missions; and the effects of the extended principle of equivalence claimed in claim 55.

61. The specification of the actual speed of an accelerating space ship that is using thrust levitation propulsion comprising:
a computation of the actual speed of the space ship onboard the ship and with respect to the Earth and with respect to the destination of the ship (the actual relative speed of the accelerating ship with respect to the earth or any other frame of reference must be measured on the ship by computing the relative speed of the ship);
the relative speed of the space ship is computed by integrating the instantaneous acceleration of the ship over the passage of time as measured onboard the ship in the gravity compensated 1 g₀ level crew quarters;
the crew onboard a ship would compute that their speed quickly exceeded the speed of light and even exceeded many multiples of the speed of light;
as a result, the space ship and crew would be able to make interstellar trips of tens and even hundreds of light years distance in mere months of onboard travel time; and
because of the acceleration, or equivalent gravity, compensated crew quarter environment onboard the space ship, the crew would always be maintained at a 1 g₀ acceleration environment level.

62. Travel time onboard a space ship comprising;
maintaining the space ship time in exact synchronization with and in step with the passage of time on the earth because of the effects of the extended principle of equivalence, as claimed on claim 55; and
because the space ship and the Earth would both have uniform 1 g₀ level gravity field environments.

63. Concepts and systems that allow the passage of time on a space ship to be controlled comprising:
the use of the extended principle of equivalence;
faster than light speed travel;
travel time synchronization with Earth and other locations with uniform 1 g₀ level gravity field environments; and
specifying how to avoid having the passage of time on the space ship influenced by the tie dilation effects of Einstein's Special Relativity.

64. Concepts and systems that allow stellar space trips missions to be carried out using inter dimensional space travel comprising;
the use of faster than light speeds and warp speed acceleration levels;
accelerated compensated crew quarters by using traction and repulsion force beam systems; and
the use of nuclear powered thrust levitation systems.

65. Concepts and systems that allow stellar space missions to be performed using inter dimensional space travel and onboard space ship time comprising:
controlling the rate at which the onboard crew ages such that the rate is not in accordance with the predictions of time dilation, but rather is in accordance with the extended principle of equivalence, as claimed in claim 55.

66. Ability to synchronize the round trip travel time of a star ship crew with Earth time comprising:
inter dimensional travel, as claimed in claim 65, both on the outward bound journey to a stellar destination and then again on the return journey such that the trips are made by maintaining the age of the crew in exact synchronization with their associates who are left behind on Earth.

67. A definitive definition for inter dimensional space travel comprising:
a set of space ship performance and operational equations for the following quantities: ship speed, distance traveled, and the ship acceleration levels as presented in sections 5.2.2 and 5.3.

68. The significance of the inter dimensional space travel equations comprising:
a descriptive presentation set forth above that is helpful in understanding and interpreting the significance of the equations; and table data for the equations that specify the ship onboard travel times and the associated passage of time on the Earth.

69. Concepts for understanding and specifying inter dimensional space travel distances comprising:
table data disclosed herein and the equations for the large distances that can be traveled during the short times that pass onboard a space ship for the crew who are maintained in a 1 g₀ environment as the ship and crew travel at the warp speed data examples included in the tables.

70. A set of defining equations and documentation for the concept and meaning of warp speed comprising:
the warp equation and the concept of warp speed;
as formulated in this invention disclosure, warp speed has proven to be a particularly convenient approach for specifying acceleration levels over a broad range and provides a convenient parameter, W, for use in specifying the performance of a stellar space ship over a very broad range of effective ship speeds, i. e. acceleration levels and for use in specifying the meaning of inter dimensional travel as claimed in claims 60, 66, 67, 68, and 69;
for specifying thrust levitation space ship performance requirements and design requirements; and the warp equation, warp number W, a definition for vehicle acceleration as claimed in claim 51, and complete warp speed documentation which is a part of this invention disclosure.

71. The warp speed parameter W comprising:
impulse speed for warp speed values in the range of W greater than 0 to less than 1, and the warp speed values from 1 to 10 which are based on the television series Star Trek Voyager and in particular on the 1995-1996 series episode 75 “Threshold” during which Lieutenant Tom Paris crosses the trans Warp threshold barrier to Warp 10 in the shuttle craft Cockeran;
a defining mathematical definition entitled the warp equation that is unique to this invention disclosure and that is a part of this invention disclosure.

72. A definition of the warp number that is a measure of space ship acceleration comprising:
a parameter W that is defined by the warp equation, is defined over the range of values from 0 to 10, where a value of W=10 is not considered to be a physically realizable value, although the warp number, W, is an open ended scale that can, in a mathematical sense, exceed the value of 10; and
the defining warp equations claimed in claim 70.

73. The term warp speed is an acronym comprising:
use as a synonym for warp W; and
is defined as the operational speed envelope that is attained during acceleration at warp number W during any arbitrary period of time as measured onboard the accelerating vehicle in an acceleration compensated crew quarter area that is maintained at 1 g₀ acceleration level.
